(19) United States
(12) Patent Application Publication
(10) Pub. No.: US 2011/0234676 A1
(43) Pub. Date: Sep. 29, 2011

(54) METHOD OF PRINTING TEST PATTERN AND INKJET RECORDING APPARATUS

(76) Inventor: Baku NISHIKAWA, Kanagawa-ken (JP)

(21) Appl. No.: 13/069,947

(22) Filed: Mar. 23, 2011

(30) Foreign Application Priority Data
Mar. 24, 2010 (JP) 2010-068235

(51) Int. Cl. B41J 29/393

(52) U.S. Cl. 347/19

(57) ABSTRACT

A test pattern is printed for ascertaining ejection characteristics of nozzles arranged in a recording head in an inkjet recording apparatus which forms and records a desired image on a recording medium by performing ejection of droplets of liquid from the nozzles and deposition of the droplets onto the recording medium. Ejection of droplets of the liquid from the recording head is performed by applying, to the recording head, a drive signal having a test waveform in which at least one of a voltage, a frequency and a waveform shape is altered with respect to a drive signal having a recording waveform which is applied to the recording head when the desired image is formed, to thereby perform the ejection with an increased ejection force compared with a case where the drive signal having the recording waveform is applied; and the test pattern is formed by the ejected droplets.

### BACKGROUND OF THE INVENTION

1. Field of the Invention

The present invention relates to a method of printing a test pattern for detecting blockages and the like in nozzles of an inkjet head, and to maintenance technology for eliminating ejection defects.

2. Description of the Related Art

In an inkjet head, drying occurs in the vicinity of the nozzle opening sections in nozzles which have not performed ejection for a long period of time, and as a result of this there is a problem in that the ink viscosity increases and blockages occur. In an inkjet recording apparatus, an operation is carried out to discharge ink in the nozzle opening sections by performing preliminary ejection of ink (also referred to as “dummy shot” or “dummy ejection”) after a prescribed time interval or before starting printing. For example, Japanese Patent Application Publication No. 2001-225485 discloses a method in which at least one of the number, interval, ejection period or ejection voltage of the preliminary ejection operations is varied in order to eject droplets satisfactorily at all times.

Japanese Patent Application Publication No. 2000-334972 discloses technology for suppressing an accumulation of burnt deposits in the peripheral area of heaters in an inkjet head using a method which ejects ink droplets by using thermal energy from electrical-thermal converting elements (heaters), by driving the heaters at a higher voltage than a normal recording operation, when performing a preliminary ejection operation, in order to prevent decline in the ejection volume, or the like, caused by the accumulation of burnt deposits in the peripheral area of the heaters.

Japanese Patent Application Publication No. 04-133747 discloses a composition in which a test pattern is developed from a CPU (central processing unit) with the object of printing a test pattern by means of a simple composition, without providing a ROM (read-only memory) for generating a test pattern, or the like, and further describes using a test pattern printing operation as an alternative to dummy ejection as a preventative measure against blockages, and reducing the number of dummy ejection operations after printing a test pattern.

However, in recent heads having increased density, there is a marked problem (e.g., the occurrence of air currents or cross-talk) due to a plurality of nozzles being driven simultaneously, and the performing of dummy shots actually ends up soiling the nozzle surface. For example, in Japanese Patent Application Publication No. 2001-225485, by carrying out dummy shots from all of the nozzles, disturbance in the air flow below the nozzle surface arises and fluid interaction (cross-talk), or the like, occurs between adjacent nozzles which are connected to the same flow channel in the head, thus causing ejection to become instable. Hence, there is a possibility that liquid separated from the meniscus will adhere to the vicinity of the nozzle openings and degrade the state of the nozzle surface. This is a marked issue in the case of high-density nozzles in a matrix head, in which a plurality of nozzles are arranged in a matrix configuration.

With the technology described in Japanese Patent Application Publication No. 2000-334972, similarly to Japanese Patent Application Publication No. 2001-225485, there is a possibility of, conversely, worsening the surface state of the head by means of dummy shots. Furthermore, with an ejection operation based on the application of high voltage, air bubbles are incorporated when the meniscus returns after ejection of a droplet and there is a risk of air bubbles entering into the nozzle.

In Japanese Patent Application Publication No. 04-133747, a test pattern printing operation is used instead of dummy ejection, but the printing of a test pattern involves fewer ejection actions (also referred to as “number of shots”) than a normal dummy shot operation, and has less effect in preventing blockages than dummy ejection.

A general inkjet recording apparatus in the related art employs a sequence in which, in order to prevent blockages and to restore the surface state and defective nozzles, a head is moved to a maintenance area outside the range of the paper, then maintenance, such as pressurization of the head, nozzle suctioning, wiping of the nozzle surface, and the like (also called “cleaning”), is carried out, and the head is then returned again to a position above the paper and printing is restarted. A maintenance operation of this kind takes time and put limits on the extent to which the effective printing speed (throughput) can be raised.

### SUMMARY OF THE INVENTION

The present invention has been contrived in view of these circumstances, an object thereof being to provide a method of printing a test pattern having a high effect in preventing blockages, and to provide an inkjet recording apparatus capable of increasing throughput by reducing the number of actual maintenance processes (application of pressure, suction purging, wiping, etc.) carried out outside the range of the paper.

In order to attain the aforementioned object, the present invention is directed to a method of printing a test pattern for ascertaining ejection characteristics of a plurality of nozzles arranged in a recording head in an inkjet recording apparatus which forms and records a desired image on a recording medium by performing ejection of droplets of liquid from the recording head through the nozzles and deposition of the droplets onto the recording medium while causing relative movement of the recording head and the recording medium, the method comprising the steps of: performing ejection of droplets of the liquid from the recording head by applying, to the recording head, a drive signal having a test waveform in which at least one of a voltage, a frequency and a waveform shape is altered with respect to a drive signal having a recording waveform which is applied to the recording head when the desired image is formed and recorded on the recording medium, to thereby perform the ejection with an increased ejection force compared with a case where the drive signal having the recording waveform is applied to the recording head; and forming the test pattern by depositing the droplets ejected in the ejection step onto the recording medium.

The ejection characteristics include, for instance, information relating to the presence or absence of ejection (ejection/non-ejection), deposition position error, ejected droplet volume error, and the like.

According to this aspect of the present invention, since the test pattern is printed by driving ejection with the increased ejection force compared with when forming and recording a desired image, ink of increased viscosity inside the nozzles is discharged when printing the test pattern. Thus, an effect in restoring the ejection characteristics of the nozzles which have impaired ejection characteristics is obtained, and the number of maintenance operations carried out can be reduced. Therefore, throughput is improved.

Preferably, the voltage of the test waveform is not higher than 1.3 times the voltage of the recording waveform.

Although the ejection force increases when the drive voltage is raised, ejection is disrupted if the drive voltage is raised too high. The test pattern used in order to identify a defective ejection nozzle requires ejection to be performed under stable ejection conditions, and therefore in order to print a satisfactory test pattern at the same time as obtaining an enhanced blockage preventing effect (nozzle restoring effect), the voltage of the drive signal for the test pattern formation is desirably not higher than 1.3 times the voltage of the recording waveform.

Preferably, an ejection frequency produced by the drive signal having the test waveform is not higher than 5 kHz, or not lower than 20 kHz.

When continuous ejection is performed at a low frequency of not more higher than 5 kHz, the next ejection action is performed after vibration of the meniscus caused by the previous ejection action has subsided, and therefore stable ejection is possible without the effects of residual vibration of the meniscus. Alternatively, when continuous ejection is performed at a high frequency of not lower than 20 kHz, the next ejection action is performed before the arrival of pressure waves from other nozzles, and therefore stable ejection which is free of the effects of cross-talk is possible.

According to this aspect of the present invention, it is possible to perform ejection normally for a test pattern which serves to identify a defective ejection nozzle.

Preferably, the method further comprises the steps of: identifying a defective ejection nozzle among the nozzles from a result of printing the test pattern; performing second ejection of droplets of the liquid from the recording head by further increasing an ejection force only for the defective ejection nozzle compared with a case where the drive signal having the test waveform is applied, by applying, to the recording head, a drive signal having a re-test waveform in which at least one of the voltage and the waveform shape is altered with respect to the drive signal having the test waveform; and depositing the droplets ejected in the second ejection step onto the recording medium.

It is possible either to drive only the defective ejection nozzle which has been identified, or to drive other normally functioning nozzles together with the defective ejection nozzle. However, the former option is desirable since it allows wasteful consumption of ink to be reduced.

According to this aspect of the present invention, it is possible to efficiently restore the identified defective ejection nozzle, and the ink consumption can be reduced in comparison with the preliminary ejection (maintenance) in the related art.

Preferably, the method further comprises the steps of: reprinting a test pattern after the second ejection step and before starting to form and record the desired image; and identifying a defective ejection nozzle among the nozzles from a result of reprinting the test pattern.

According to this aspect of the present invention, ejection with a further strengthened ejection force is performed from the defective ejection nozzle that has been identified from the results of printing the first test pattern, and the effect of restoration can be confirmed in the second test pattern. By identifying the defective ejection nozzle from the results of printing the second test pattern and carrying out image correction, and the like, on the basis of this information, it is possible to perform good correction as well as improving throughput.

Preferably, the method further comprises the steps of: identifying a defective ejection nozzle among the nozzles from a result of printing the test pattern; driving only the defective ejection nozzle to eject a droplet of the liquid; and depositing the droplet ejected in the driving step onto the recording medium.

According to this aspect of the present invention, it is possible to promote restoration by repeatedly driving ejection of only the defective ejection nozzle. A waveform having increased ejection force compared with the recording waveform is desirable as the drive waveform applied in this case, but even if the waveform is the same as the recording waveform, a relative effect in promoting restoration is obtained by performing an ejection operation repeatedly, a plurality of times.

Preferably, the test pattern includes line patterns respectively for the nozzles whereby a result of ejection of each of the nozzles is identified distinguishably from results of ejection of others of the nozzles on the recording medium.

In order to ascertain the individual ejection characteristics of each nozzle from the results of printing the test pattern, a desirable mode is one where the printed test pattern includes the line patterns of the nozzles which allow the droplet ejection results by each nozzle to be distinguished clearly on the recording medium.

Preferably, the test pattern includes the line patterns formed by performing ejection simultaneously from the nozzles in positions separated from each other by an interval of larger than one nozzle pitch in an effective sequence of the nozzles aligned in a widthwise direction of the recording medium which is perpendicular to the direction of the relative movement, in such a manner that no ejection is performed simultaneously from the nozzles which are mutually adjacent in the effective sequence of the nozzles.

According to this aspect of the present invention, it is possible to ascertain the droplet ejection results of the nozzles individually, in correspondence with the respective nozzle positions. Furthermore, by avoiding simultaneous driving of mutually adjacent nozzles, it is possible to reduce the effects of cross-talk.

Preferably, the test pattern is formed by performing the ejection while raising the voltage of the drive signal stepwise.

According to this aspect of the present invention, it is possible raise the blockage preventing effect yet further while still preserving the function to form a test pattern. For example, if ejection is performed by raising the voltage stepwise from 1 time, to 1.2 times, to 1.4 times, to 1.6 times the voltage of the recording waveform, then it is desirable to use the 1 time and/or the 1.2 times ejection portion in which stable ejection can be expected, for determination purposes when determining the ejection characteristics of the nozzles.

Preferably, the test pattern is formed by performing the ejection while changing an ejection frequency stepwise.

According to this aspect of the present invention, it is possible to perform ejection in a stable frequency region which varies as a result of increased viscosity of the ink.

Preferably, modulation of the ejection frequency is performed using test pattern image data.

According to this aspect of the present invention, it is possible to implement the method of printing the test pattern according to the present invention by means of the instructed image data only, without making improvements to the apparatus, and therefore introduction is simplified.

Preferably, the test pattern has a portion in which ejection is performed by applying a drive signal having the recording waveform and a recording frequency after the ejection is performed by applying the drive signal having the test waveform.

According to this aspect of the present invention, it is possible to check the state of restoration of the nozzles as a result of printing the test pattern, by observing the test pattern.

Preferably, the test waveform contains a section in which rectangular waves are arranged at an interval substantially equal to a resonance period of the recording head.

The head resonance period (Helmholtz intrinsic resonance period) is the intrinsic period of the whole vibrating system, which is determined by the ink flow channel system, the ink (acoustic element), and the dimensions, material and physical values of the pressure generating element, and the like.

According to this aspect of the present invention, the restoration effect is further enhanced by raising the ejection efficiency.

Preferably, the printing of the test pattern is performed, before starting to form and record the desired image, after performing at least a specified number of droplet ejections to form and record the desired image, and/or after forming and recording at least a specified number of the desired image.

For example, printing of the test pattern according to this aspect of the present invention is performed at a suitable timing, such as before starting a print job, when a specified number of sheets have been printed during the course of implementing a print job, or when a specified number of droplet ejection actions have been performed during the course of implementing a print job.

According to this aspect of the present invention, it is possible to reduce the number of maintenance operations required in the related art, and therefore throughput is improved.

In order to attain the aforementioned object, the present invention is directed to an inkjet recording apparatus, comprising: a recording head which includes a plurality of nozzles through which droplets of liquid are ejected and a plurality of pressure generating elements corresponding to the nozzles; a conveyance device which causes relative movement of the recording head and a recording medium by conveying at least one of the recording head and the recording medium; a recording ejection control device which forms and records a desired image on the recording medium by controlling ejection of droplets from the recording head while controlling the relative movement, and by depositing the droplets onto the recording medium; and a test pattern formation control device which controls ejection of droplets from the recording head in such a manner that, when a test pattern for ascertaining ejection characteristics of the nozzles is printed on the recording medium, the recording head is applied with a drive signal having a test waveform in which at least one of a voltage, a frequency and a waveform shape is altered with respect to a drive signal having a recording waveform which is applied to the recording head when the desired image is formed and recorded on the recording medium, to thereby perform the ejection with an increased ejection force compared with a case where the drive signal having the recording waveform is applied to the recording head, and in such a manner that the test pattern is formed by depositing the ejected droplets onto the recording medium.

According to this aspect of the present invention, it is possible to perform ejection having a restoring effect (blockage preventing effect) similar to the effects of preliminary ejection in the related art, at a head position opposing the recording medium where ejection is possible (within the image forming area), rather than withdrawing the recording head to a maintenance position, or the like. Therefore, a test pattern is obtained which can be used to determine the ejection characteristics of the respective nozzles, as well as being able to improve throughput.

Preferably, the inkjet recording apparatus further comprises: an image reading device which reads in a result of printing the test pattern; and a signal processing device which performs calculation for identifying a defective ejection nozzle among the nozzles from information acquired by the image reading device.

The test pattern printed on the recording medium is read in by the image reading device, such as an optical sensor, and a defective ejection nozzle can be identified by analyzing and measuring the read test pattern. Furthermore, it is also possible to measure the deposition position error and/or ejected droplet volume error of each nozzle.

Preferably, the inkjet recording apparatus further comprises an image correction device which compensates for an output of a defective ejection nozzle among the nozzles identified from a result of printing the test pattern, using the nozzles other than the defective ejection nozzle.

According to this aspect of the present invention, when forming and recording a desired image, it is possible to correct the effects of reduced image quality caused by the defective ejection nozzle, by employing the peripheral, normally functioning nozzles. Thereby, it is possible to maintain recording stability, and continuous recording with stable output quality is possible.

According to the present invention, it is possible to simplify or omit preliminary ejection operations in the related art by printing a test pattern having a high blockage preventing effect, and therefore the number of maintenance operations can be reduced.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a plan diagram showing a nozzle arrangement in a head module;

FIGS. 2A and 2B are schematic drawings showing line patterns formed on paper;

FIG. 3 is a diagram showing a test pattern printed in the present embodiment;

FIG. 4 is a plan diagram of paper;

FIG. 5 is a waveform diagram showing voltage waveforms of drive signals;

FIG. 6 is a graph showing a relationship between the occurrence of abnormalities during continuous ejection and the ejection frequency;

FIG. 7 is a waveform diagram showing voltage waveforms of drive signals;

FIG. 8 is a flowchart showing a control of a printing operation in an inkjet recording apparatus according to an embodiment of the present invention;

FIG. 9 is an illustrative diagram showing line patterns printed while changing the drive voltage stepwise;

FIG. 10 is an illustrative diagram showing line patterns printed while changing the ejection frequency stepwise;

FIG. 11 is a diagram showing an example where a line formed by ejection using a normal waveform (recording waveform) is added after the end portion of the line patterns shown in FIG. 9;

FIG. 12 is a flowchart showing a control of a printing operation in an inkjet recording apparatus according to another embodiment of the present invention;

FIG. 13 is a schematic drawing of an inkjet recording apparatus according to an embodiment of the present invention;

FIGS. 14A and 14B are plan view perspective diagrams showing the structure of a print head;

FIGS. 15A and 15B are plan view perspective diagrams showing further examples of the structure of a print head;

FIG. 16 is a cross-sectional diagram along line 16-16 in FIGS. 14A and 14B;

FIG. 17 is a plan view perspective drawing showing the structure of flow channels inside a print head;

FIGS. 18A, 18B and 18C are schematic drawings showing further examples of the structure of flow channels inside print heads;

FIG. 19 is a block diagram showing the composition of a control system of the inkjet recording apparatus; and

FIG. 20 is a schematic drawing of an in-line sensor (determination unit).

### DETAILED DESCRIPTION OF THE PREFERRED EMBODIMENTS

### Method of Printing Test Pattern

In general, in an inkjet head (hereinafter referred to simply as the “head”) in which a plurality of nozzles are arranged at high density, the desirable conditions for correctly performing ejection without affecting peripheral nozzles are, for instance: (1) that a small number of nozzles are simultaneously driven, and (2) that nozzles which are mutually adjacent, or nozzles having a common flow channel, are not simultaneously driven.

In the present embodiment, a test pattern that satisfies the above-described conditions (1) and (2) is produced in order to accurately ascertain the ejection characteristics of the respective nozzles (the presence or absence of ejection, ejected droplet deposition position error, ejected droplet volume error, and the like) from the results of printing a test pattern. The test pattern is used in order to raise the print quality by identifying defective ejection nozzles (nozzles producing a recording defect, such as ejection failure, ejection volume abnormality, ejected droplet deposition position abnormality, or the like), and applying correction to the supplied image data or the waveform of the drive voltage signal. Hence, when printing the test pattern, it is necessary to drive the respective nozzles under conditions for normal ejection, without affecting other, peripherally located, nozzles. Moreover, in order to clearly distinguish the droplet ejection results produced by each nozzle from the droplet ejection results produced by other nozzles, it is necessary that dots formed by droplets ejected from different nozzles be recorded at a sufficient distance apart in order to avoid overlap therebetween on the surface of the paper.

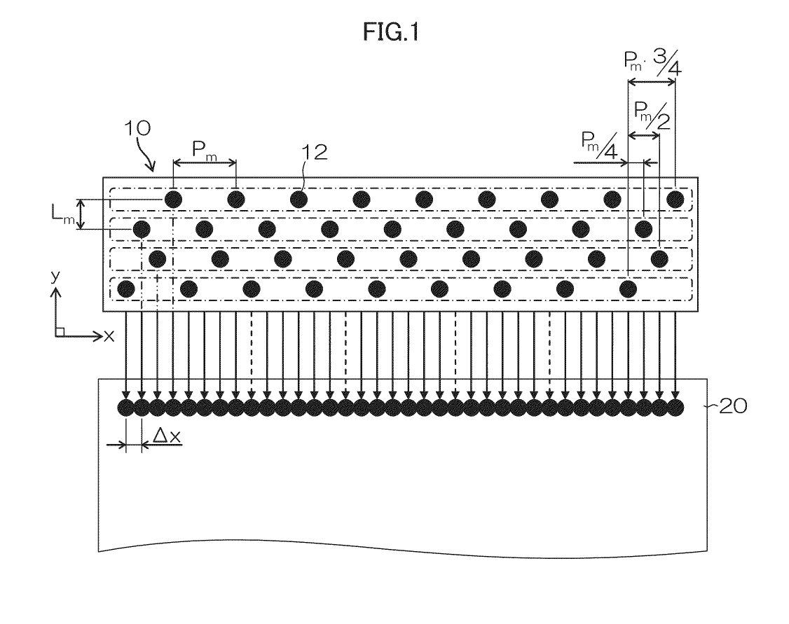

An embodiment of the test pattern that satisfies these requirements is described below. Here, a head module 10 having a nozzle arrangement such as that shown in FIG. 1 is described by way of an example; however, in implementing the present invention, the mode of the nozzle arrangement is not limited in particular. The head module 10 can constitute a recording head individually (by one head module), or alternatively, a recording head can be constituted by combining (joining together) a plurality of head modules 10.

As shown in FIG. 1, paper 20 (corresponding to the “recording medium”) is conveyed from bottom to top in FIG. 1, with respect to the head module 10 having a nozzle surface (ink ejection surface) in which a plurality of nozzles 12 are arranged in a two-dimensional configuration. In the following description, the conveyance direction of the paper 20 is a y direction and the paper widthwise direction perpendicular to the y direction is an x direction. For the sake of convenience, a schematic view with a reduced number of nozzles is depicted in the drawings, but it is possible to adopt a mode in which several hundred to several thousand of nozzles are formed in one head module.

### <Description of Nozzle Arrangement>

The head module 10 shown in FIG. 1 has four nozzle rows, which have different positions in the y direction, respectively. The lowest row in FIG. 1 is referred to as a first nozzle row, the row above the first nozzle row is referred to as a second nozzle row, the row above the second nozzle row is referred to as a third nozzle row, and the uppermost row is referred to as a fourth nozzle row. Looking in particular at each of the nozzle rows, the nozzle pitch Pₘ in the x direction within each row is uniform. Taking the nozzle positions of the first nozzle row as a reference, the nozzle positions of the second nozzle row are shifted by Pₘ/2 in the x direction. The nozzle positions of the third nozzle row are shifted by Pₘ/4 in the x direction with respect to the nozzle positions of the first nozzle row, and the nozzle positions of the fourth nozzle row are shifted by Pₘ×¾ in the x direction with respect to the nozzle positions of the first nozzle row. If the nozzles arranged in the staggered configuration including four rows in this way are projected onto the x axis, then the nozzles are aligned at a uniform pitch (Pₘ/4) in the x direction. In other words, the head module 10 has a minimum recording pitch (dot pitch) Δx of Pₘ/4 in the x direction on the paper 20.

As the paper 20 is conveyed, the first nozzle row, which is situated on the furthest upstream side in terms of the paper conveyance direction (the y direction), performs ejection first, after which droplet ejection is performed from the respective nozzle rows in the sequence, second row, third row, fourth row, at droplet ejection timings having a time difference (Lₘ/v) specified by the paper conveyance speed v and the nozzle row pitch (distance between nozzle rows in the y direction) Lₘ; and thereby it is possible to form a line of dots aligned in the x direction. In FIG. 1, the pitch between the nozzle rows (distance in the y direction) Lₘ is uniform, but it is also possible to adopt a mode in which the row pitch varies.

Looking at the alignment sequence of the dots aligned in mutually adjacent positions in the x direction on the paper 20, and the correspondence between the nozzles which record the respective dots, in respect of a line (dot row) in the x direction recorded by the head module 10 in FIG. 1, there is a dot formed by a droplet ejected by one of the nozzles of the first row, and there are a dot formed by a droplet ejected by one of the nozzles of the third row in the right-hand adjacent position to the dot formed by the nozzle of the first row, a dot formed by a droplet ejected by one of the nozzles of the second row in the right-hand adjacent position to the dot formed by the nozzle of the third row, a dot formed by a droplet ejected by one of the nozzles of the fourth row in the right-hand adjacent position to the dot formed by the nozzle of the second row, and a dot formed by a droplet ejected by another nozzle of the first row in the right-hand adjacent position to the dot formed by the nozzle of the fourth row, whereupon a similar sequence is successively repeated. In other words, when the nozzle row numbers which form the dot rows aligned in the x direction are expressed in the dot alignment sequence, there is a periodicity based on a repeated unit of four nozzles as “1→3→2→4→1→3→2→4→ . . . ”.

In this way, when the matrix-shaped nozzle arrangement shown in FIG. 1 is replaced by a nozzle row aligned effectively in one row at different nozzle positions in the x direction (a nozzle row projected orthogonally onto the x axis) and the resulting nozzle alignment sequence is observed, a periodic arrangement based on a sequence “1→3→2→4” of the nozzle row numbers is obtained. Here, the repetition unit is regarded as “1→3→2→4”; however, the repetition unit can also be regarded as any of “3→2→4→1”, “2→4→1→3”, and “4→1→3→2”.

The alignment sequence of nozzles 12 capable of forming a dot row in the x direction on the paper 20 at a pitch (Δx) corresponding to the recording resolution (the alignment sequence of nozzles obtained by projecting the nozzle arrangement in the head module 10 orthogonally onto the x axis) gives the effective nozzle arrangement. In the present specification, the nozzles which are in a mutually adjacent positional relationship in the nozzle alignment sequence of this effective nozzle row (the projected nozzle row on the x axis) are referred to as “adjacent nozzles”. In other words, even nozzles which are not necessarily in adjacent positions in the nozzle layout in the head module 10 are referred to as the “adjacent nozzles” if they are aligned in adjacent positions when viewed as the projected nozzle row on the x axis of the paper 20.

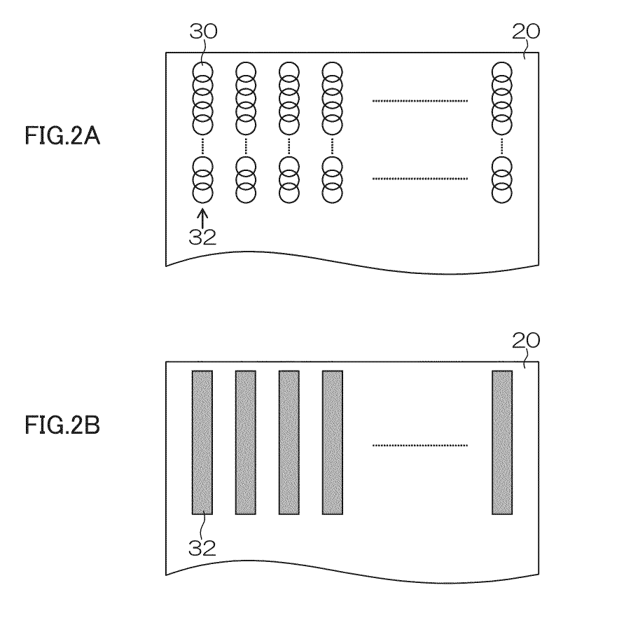

FIGS. 2A and 2B are examples in which lines following the y direction on the paper 20 are formed by the head module 10 in FIG. 1. FIGS. 2A and 2B show examples in which droplets are ejected by the first (bottommost) nozzle row in the head module 10 in FIG. 1.

By conveying the paper 20 at a uniform speed in the y direction while ejecting droplets toward the paper 20 from the nozzles 12 of the head module 10, the ink droplets land on the paper 20 and, as shown in FIG. 2A, a dot row (line 32) is formed in which dots 30 formed by the droplets deposited from each nozzle 12 is arranged in a line shape. The lines 32 in FIG. 2A are formed by droplets which are consecutively ejected from the respective nozzles 12 (i.e., mutually different nozzles). In the case of a line head having high density, when droplet ejection is performed simultaneously from all of the nozzles, dots formed by adjacent nozzles are partially overlapping on the paper 20, and therefore no line consisting of one dot row is formed for each separate nozzle. In order that the respective lines 32 recorded by the different nozzles 12 do not overlap with each other on the paper 20, the interval between the nozzles which simultaneously perform ejection is desirably at least two nozzle pitches in the projected nozzle row, and preferably, three or more nozzle pitches.

FIG. 2B shows a simplified view of the lines 32 shown in FIG. 2A. For the sake of convenience, depictions such as in FIG. 2B are hereinafter used for the lines 32 created by rows of deposited dots formed by consecutively ejected droplets.

### <Specific Example of Test Pattern>

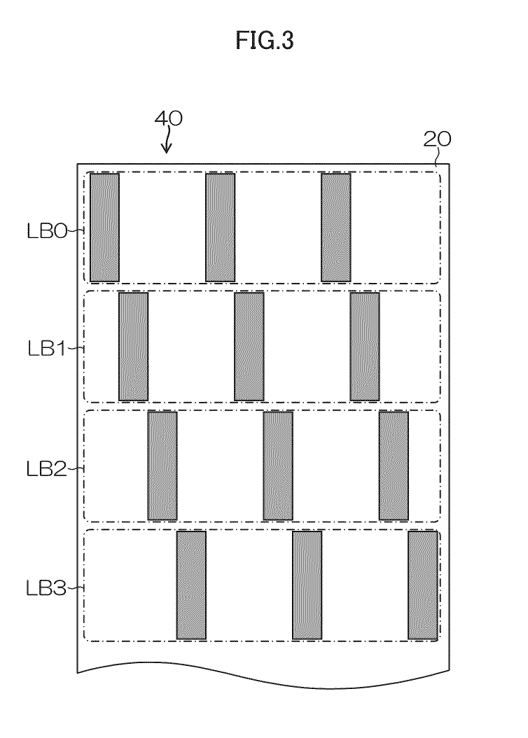

FIG. 3 is a diagram showing an example of a test pattern according to the present embodiment. In order that the droplet ejection result of each of the nozzles 12 in the head module 10 can be clearly distinguished from those of the other nozzles, line patterns corresponding to the nozzles 12 are formed as shown in FIG. 3, for example. The number of lines is reduced in the illustration, for the sake of convenience.

The test pattern 40 in FIG. 3 includes a plurality of line blocks (here, four line blocks 0 to 3 are depicted) LB0 to LB3. Each of the line blocks LB1 (i=0, 1, 2, 3) includes a plurality of lines (group of lines), which are formed in the y direction by the nozzles at uniform intervals apart.

The nozzle numbers are defined as 0, 1, 2, 3, . . . , sequentially from the left-hand end in FIG. 1, in the nozzle alignment sequence of the effective nozzle row of the nozzle arrangement shown in FIG. 1 (the nozzle numbers can also be defined from the right-hand end). The line block LB0 shown in FIG. 3 is formed by simultaneous droplet ejection from the nozzles having the nozzle numbers expressed as “4N+0”, where N is 0 or a positive integer, such as the nozzle numbers 0, 4, 8, . . . (i.e., the block of the group of lines formed by the nozzles having the nozzle numbers corresponding to multiples of 4). The line block LB1 is formed by the nozzles having the nozzle numbers “4N+1”, such as the nozzle numbers 1, 5, 9, and so on. The line block LB2 is formed by the nozzles having the nozzle numbers “4N+2”, and the line block LB3 is formed by the nozzles having the nozzle numbers “4N+3”. Lines corresponding to all of the nozzles 12 of the head module 10 are formed in the four line blocks LB0 to LB3.

In the present embodiment, the example based on 4N+M (M=0, 1, 2, 3) is described; however, the composition is not limited to multiples of four. In general, the formula AN+B (B=0, 1, . . . , A−1) where A is an integer larger than 1 can be applied. More specifically, in one line head, when nozzle numbers are assigned in sequence from the end in the x direction to the nozzles which constitute a nozzle row aligned effectively in one row following the x direction (the effective nozzle row obtained by orthogonal projection onto the x axis), then the nozzles which simultaneously perform ejection are divided up on the basis of the remainder “B” produced when the nozzle number is divided by an integer “A” of 2 or greater (B=0, 1, . . . , A−1), and lines produced by continuous droplet ejection from the nozzles are formed respectively by altering the droplet ejection timing for each group of nozzle numbers: AN+0, AN+1, . . . , AN+B (where N is an integer not smaller than 0).

Thus, it is possible to form an independent line for every nozzle which can be distinguished from lines formed by the other nozzles, and there is no overlap between mutually adjacent lines within each line block. Apart from a line pattern of a so-called “1-on, n-off' type described above, the test pattern may also include other patterns, such as other line blocks (for example, a block for confirming relative position error between line blocks), horizontal lines (dividing lines) which divide between the line blocks, and the like. Furthermore, in the case of an inkjet recording apparatus having a plurality of heads of different ink colors, similar line patterns are formed for each of the heads corresponding to the ink colors (for example, the heads corresponding to the respective colors of C, M, Y and K).

There are no particular restrictions on the number of ejection shots required to form the line patterns corresponding to the respective nozzles. Although it also depends on the size of the paper 20, and the like, the general yardstick is about several hundred shots per nozzle (for example, 400 shots).

### <Test Pattern Forming Position on Paper>

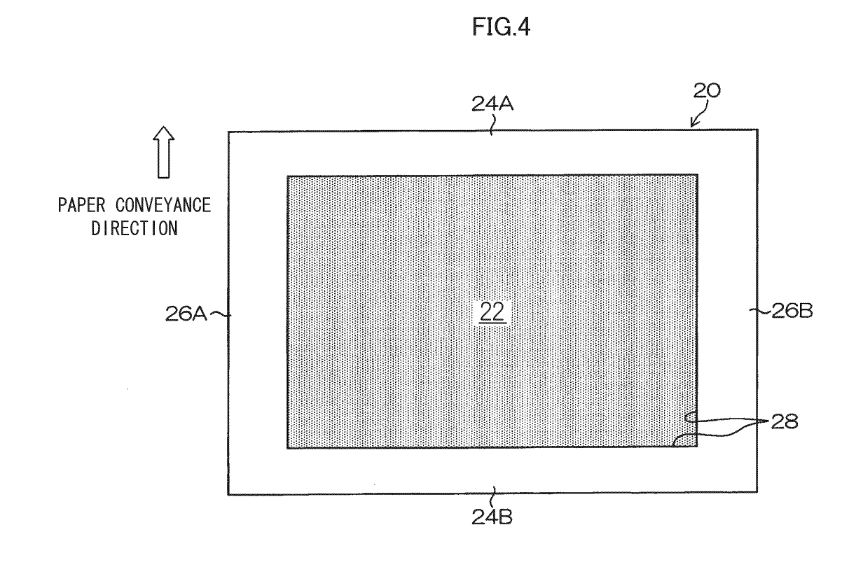

The test pattern according to the present embodiment can be formed at any position on the paper 20. In other words, all or a portion of the test pattern can be recorded on the image forming region (image formation area) 22 on the paper 20, as shown in FIG. 4, and all or a portion of the test pattern can be recorded in the blank margin portions (“non-image forming regions”) 24A, 24B, 26A and 26B in the outer periphery (front, rear, left-hand and right-hand sides) of the image forming region 22. The image forming region 22 is a region where a target image (which corresponds to a “desired image”) is formed. After recording a desired image on the image forming region 22, the paper 20 is cut along cutting lines 28 to remove the peripheral non-image portions, and the image portion of the image forming region 22 remains as a print product.

On the other hand, the preliminary ejection is not performed toward the image forming region 22 of the paper 20. The preliminary ejection may be performed toward the blank margin portions of the paper 20; however, normally the head is withdrawn from the image formation position, and ejection (preliminary ejection) is performed toward an ink receptacle in a maintenance station, which is situated at a maintenance position outside the range of the paper.

### <Test Pattern Printing Conditions>

In the present embodiment, from the viewpoint of achieving a high nozzle restoring effect in a test pattern printing operation for identifying defective ejection nozzles, at least one of the voltage, frequency (period) and shape of the drive waveform is changed to a special voltage, frequency or shape for the test pattern. The drive signal for printing the test pattern has a waveform (referred to as a “test waveform”) in which at least one of the voltage, frequency and shape is changed from a drive signal having a normal recording drive waveform, which is used when recording a desired image (print target image) on the image forming region 22. In the drive signal having the test waveform, at least one element of the voltage, frequency and shape is changed in such a manner that the ejection force is increased with respect to the drive signal having the normal recording waveform.

By thus printing the test pattern by ejection having the increased ejection force compared with the normal image recording, it is possible to identify defective ejection nozzles from the results of printing the test pattern, as well as having an effect in restoring the ejection performance of the nozzles by means of the test pattern printing operation. Consequently, in a state which, in the related art, would require the apparatus to be transferred to maintenance mode, the head to be withdrawn to outside the range of the paper from the printing position, and maintenance (restoration processing), such as pressure application to the ink inside the head, suction of the nozzles and wiping of the nozzle surface, and the like, to be carried out in a maintenance station located outside the range of the paper, it is possible to restore the surface state about the periphery of the nozzles by printing the test pattern according to the present embodiment. As a result of this, it is possible to reduce the number of times that the aforementioned maintenance operation is performed, and therefore throughput can be raised.

### <Drive Voltage>

In general, the ejection force tends to increase, the higher the drive voltage. However, if the drive voltage is raised excessively, then this can cause disturbance of the ejection action, and the test pattern ceases to serve its original purpose, namely, to identify defective ejection nozzles. Therefore, from the viewpoint of increasing the nozzle restoring effect at the same time as ensuring suitable formation of the test pattern (i.e., stable ejection), it is desirable that the voltage of the drive signal for forming the test pattern has an upper limit of 1.3 times the voltage of the normal ejection waveform (ejection for image formation and recording).

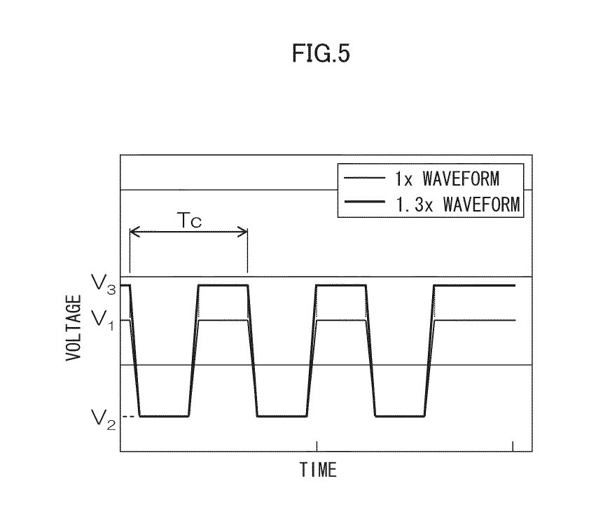

FIG. 5 shows one example of a drive waveform. In FIG. 5, the waveform represented with thin lines (the rectangular waveform having a maximum potential of V₁ and a minimum potential of V₂) is the normal drive waveform for recording, and the waveform represented with thick lines (the rectangular waveform having a maximum potential of V₃ and a minimum potential of V₂) is the waveform for test pattern formation (which corresponds to the “test waveform”).

The voltage of the waveform for test pattern formation (potential difference |V₃−V₂|) is set to be not less than 1 time and not more than 1.3 times the voltage of the normal drive waveform for recording (potential difference |V₁−V₂|). The waveform having the voltage of 1.3 times the voltage of the normal drive waveform for recording is referred to as the “1.3× waveform”, and similar expressions such as a “1.5× waveform” are also used.

### <Ejection Frequency>

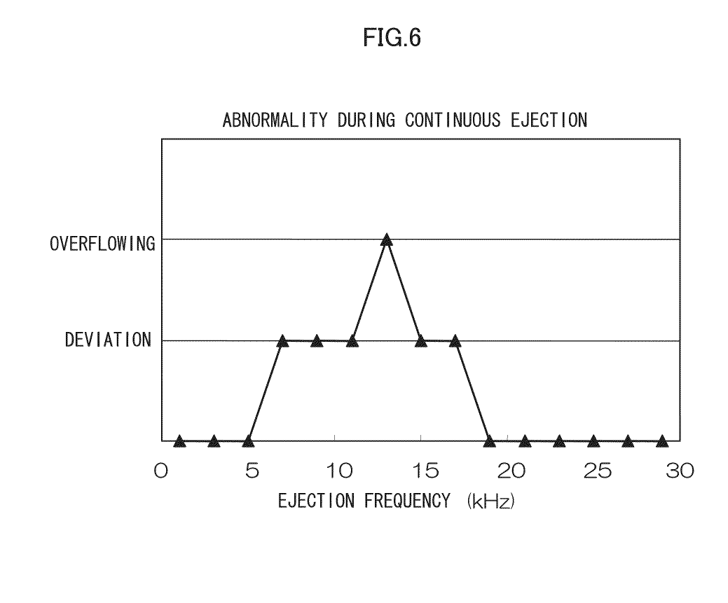

The ejection frequency for test pattern formation is desirably a low frequency (not higher than 5 kHz) capable of performing stable ejection, or a high frequency (not lower than 20 kHz) at which the refilling of each nozzle has normal or slightly negative pressure. FIG. 6 shows the results of related experimentation. FIG. 6 shows an investigation of the relationship between the occurrence of abnormalities (ejection deviation, overflow of liquid onto the periphery of the nozzles) during continuous ejection, and the ejection frequency. The horizontal axis represents the ejection frequency and the vertical axis represents the state of abnormality. The bottommost line on the vertical axis indicates that normal ejection is performed (no occurrence of ejection abnormalities). On the low frequency side of not higher than 5 kHz, stable ejection is achieved. Above 5 kHz, there is a frequency range where ejection deviates, or liquid overflows onto the periphery of the nozzles (the range up to about 19 kHz), and then at high frequencies exceeding 19 kHz (approximately 20 kHz or higher), stable ejection becomes possible again.

Consequently, it is desirable to perform continuous ejection at an ejection frequency in the low frequency range of not higher than 5 kHz or in a high frequency range of not lower than 20 kHz, to form the lines of the test pattern.

The main cause for this phenomenon is thought to be fluid interaction (cross-talk). More specifically, when droplets are ejected from the nozzles, the meniscus inside each nozzle shakes, and in the case of a low frequency driving where the ejection period is sufficiently longer than the period of the shaking action (the period of vibration of the meniscus), then it is possible to perform the next ejection action after the shaking caused by the previous ejection action has subsided. In other words, in the low-frequency region at or below 5 kHz, stable ejection is possible since there is no effect due to residual vibration of the meniscus.

Furthermore, there may also be a phenomenon where pressure waves from other nozzles in the head are transmitted and cause the meniscus to rise up or sink inward, and if an ejection command is issued while the meniscus is moving in this way, then depending on the timing, the ejection performance deteriorates. If ejection is performed before the arrival of the pressure waves from adjacent nozzles (if ejection is performed at high frequency), then problems of this kind are eliminated and normal ejection is possible.

The reason why a desirable condition is that the refilling of each nozzle should be at slightly negative pressure is as follows. When one ejection action is performed by a certain nozzle, for example, the amount of ink inside that nozzle falls, the meniscus sinks accordingly, and the sunken meniscus is then returned to its original state by a refilling operation. Supposing that the nozzle is in an instable state and an abnormality has occurred whereby the liquid overflows outside the nozzle (to the nozzle surface), under conditions where the refilling is performed under slightly negative pressure, the meniscus is caused to sink even more deeply and hence an action of pulling the liquid that has overflowed outside the nozzle back inside the nozzle is obtained. Thus, an effect in restoring the surface state of the nozzles is achieved.

### <Ejection for Promoting Further Restoration of Defective Ejection Nozzles>

In the present embodiment, the test pattern capable of identifying defective nozzles is used, and it is possible to identify defective ejection nozzles which have not performed ejection normally, and to perform even stronger ejection driving (for example, with a 1.6× waveform, or the like) from the identified nozzles.

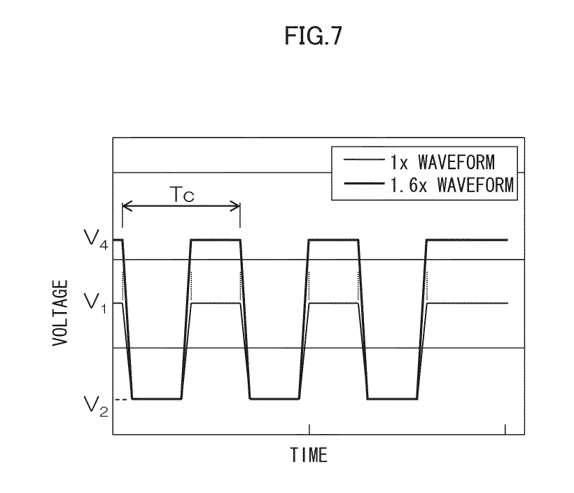

FIG. 7 shows one example of a drive waveform (corresponding to a “re-test waveform”) which is applied to a defective ejection nozzle in order to achieve a further restoring effect. In FIG. 7, the waveform represented with thin lines (the rectangular waveform having a maximum potential of V₁ and a minimum potential of V₂) is the normal drive waveform for recording, and the waveform represented with thick lines (the rectangular waveform having a maximum potential of V₄ and a minimum potential of V₂) is the waveform for enhanced restoration (corresponding to the “re-test waveform”), which is applied to defective ejection nozzles.

The voltage of the waveform for enhanced restoration (potential difference |V₄−V₂|) is set to be not less than 1 time and not more than 1.6 times the voltage of the recording drive waveform (potential difference |V₁−V₂|).

From experimentation, it was found that when the nozzles which had been identified as defective ejection nozzles from the results of printing a test pattern formed with the ejection using a 1.3× waveform, were made to perform ejection by applying a 1.5× waveform, then 75% of the nozzles were restored and became capable of performing normal ejection. This experimentation revealed that an even greater restoration effect is obtained by suitably combining printing of a test pattern and repeat ejection by defective ejection nozzles.

### First Embodiment of Control of Printing Operation in Inkjet Recording Apparatus

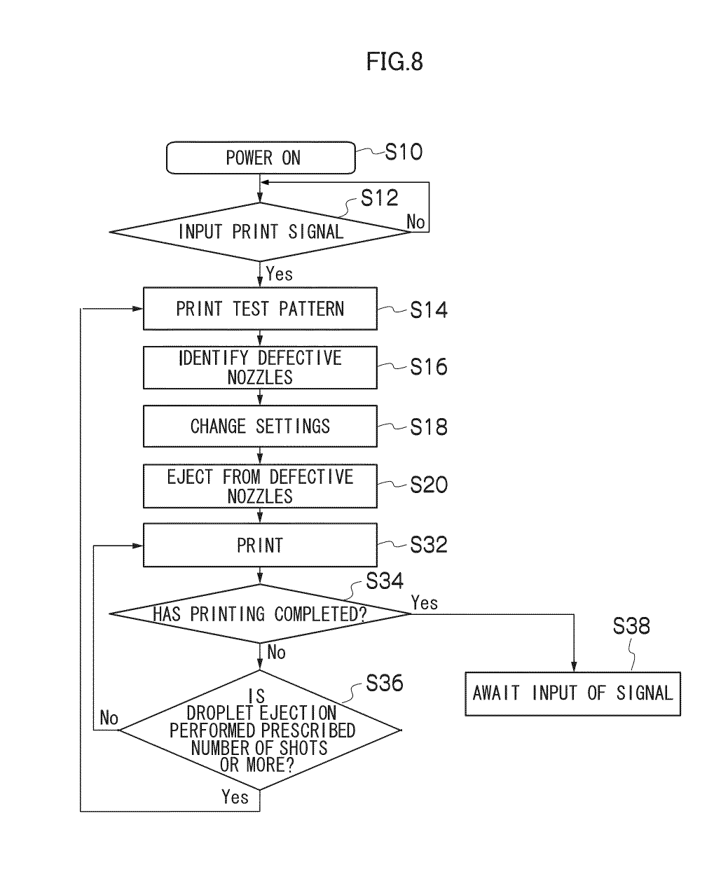

FIG. 8 is a flowchart showing a first embodiment of control of a printing operation in an inkjet recording apparatus according to the embodiment of the present invention.

When the power supply to the apparatus is switched on (step S10), either manually or by automatic control from an external source, then judgment of the input of a print signal is performed (step S12). If there is no input of a print signal, the processing in step S12 is looped and the procedure awaits the input of a print signal. The print signal may be issued in accordance with an operation performed by an operator to instruct execution of a print, or may be issued from an external apparatus, such as a host computer. When a print signal is input, a YES verdict is produced at step S12, and the procedure advances to step S14.

At step S14, a test pattern according to the present embodiment is printed. For example, the ejection force is raised by using the 1.3× waveform illustrated in FIG. 5, and a 1-on n-off type test pattern (see FIG. 3) is printed onto the image forming region 22 (see FIG. 4) of the paper 20. Thereupon, defective nozzles are identified by reading out the printed test pattern (step S16). The device for reading in the test pattern desirably employs a composition in which an inspection device (optical sensor, or the like) is incorporated into the inkjet recording apparatus. For example, a desirable mode is one where an imaging sensor, such as a CCD imaging element (which corresponds to an “image reading device”), is arranged in the inkjet recording apparatus. Here, in the case of a composition where a sensor cannot be arranged inside the apparatus, as an alternative method, it is possible to employ a mode which uses a reading apparatus such as an external scanner. In this case, after printing the test pattern, the printed object is set on the reading apparatus and reading is performed (offline reading).

According to the information about the defective nozzles identified at step S16, the drive condition settings are changed only in respect of the defective nozzles (step S18), and ejection is performed from the defective nozzles in the changed drive conditions (step S20). For example, the defective nozzles are driven by raising the ejection force yet further by using the 1.6× waveform as illustrated in FIG. 7. The ejection performed in this case does not necessarily have to be the test pattern shown in FIG. 3, and may also be a separate pattern. From the viewpoint of reducing ink consumption, it is desirable to carry out ejection only from the defective nozzles.

By driving the defective nozzles with increased ejection force (steps S18 to S20 in FIG. 8), discharge of the ink of increased viscosity is promoted and ejection defects are resolved. Even if it is not necessarily possible to restore all of the defective nozzles, restoration of at least a portion of the defective nozzles can be expected.

Thereupon, printing of a target image (actual image) corresponding to the input image data is started (step S32). In parallel with this printing operation, it is judged whether or not printing has terminated (step S34). This judgment is made on the basis of a termination signal issued upon completion of a print job, or the presence or absence of a print job interrupt/halt command signal. If printing has not terminated, then a NO verdict is produced at step S34, and the procedure advances to step S36.

At step S36, it is judged whether or not a prescribed number of droplet ejection actions or more have been performed by the printing operation. The specified amount (prescribed number of shots) forming a reference for this judgment is set in advance, and the judgment in step S36 is made by counting the number of ejection shots involved in the printing the actual image and comparing this number with the reference value (specified amount). The number of ejection shots referred to here can be the sum total of ejection shots for all nozzles, or the sum total of ejection shots in the nozzle group. Alternatively, it is also possible to use a representative value, such as the average value per nozzle (average number of shots), or the maximum value among all or a portion of the nozzles (maximum number of shots), or the like.

In the present embodiment, the “number of shots” are counted as one droplet (or one shot) for each ejection action. For example, one ejection action is performed by application of one rectangular pulse in FIG. 5, whereby one droplet is ejected and deposited, and one dot is recorded. If the actual behavior of the ejection liquid is observed, then there are cases where separated droplets such as one or more of satellites (subsidiary droplets) are produced in addition to the main droplet, by one ejection driving operation (the application of one drive pulse), and hence a plurality of droplets are ejected, but the droplet formed by the combination of these droplets at substantially the same position on the paper surface is counted as one droplet (or one shot).

At step S36, if the prescribed number of shots has not yet been reached, then the procedure returns to step S32 and the printing operation is continued. If, at step S36, it is judged that droplet ejection of a prescribed number of shots or more has been performed, then the procedure returns to step S14. In this way, the process described above (step S14 to S36) is repeated and printing is carried out. More specifically, the test pattern having the effect in preventing blockages is printed each time droplet ejection of the prescribed number of shots has been performed.

At step S34, if it is judged that printing has terminated, then the procedure advances to step S38 and enters standby awaiting the input of the next command signal. For example, it is possible that the procedure returns to step S12 and awaits the input of a new print signal, or awaits the input of another control signal.

According to this embodiment, it is possible to reduce the number of maintenance actions, and throughput is improved.

In the embodiment described above, the judgment in step S36 is based on the “prescribed number of shots”; however, it can also be based on a “number of printed sheets”, instead of or in combination with the number of shots.

### First Modification of Test Pattern

As described above, the test pattern is desirably a line pattern in order that the droplet ejection results of the respective nozzles can be independently identified. In order to complete suitable ejection for restoration by printing one test pattern, a desirable mode is one where ejection is performed while varying the drive conditions stepwise.

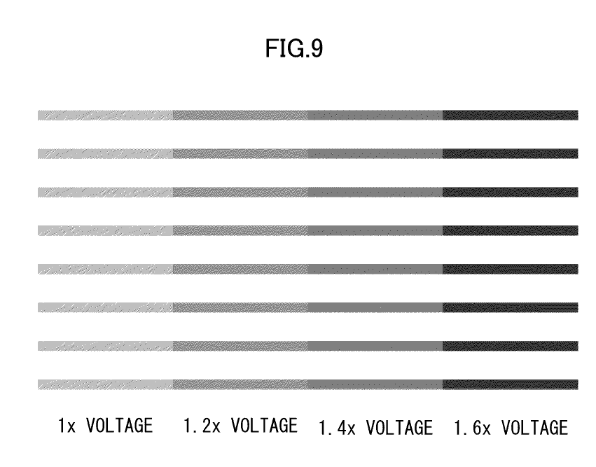

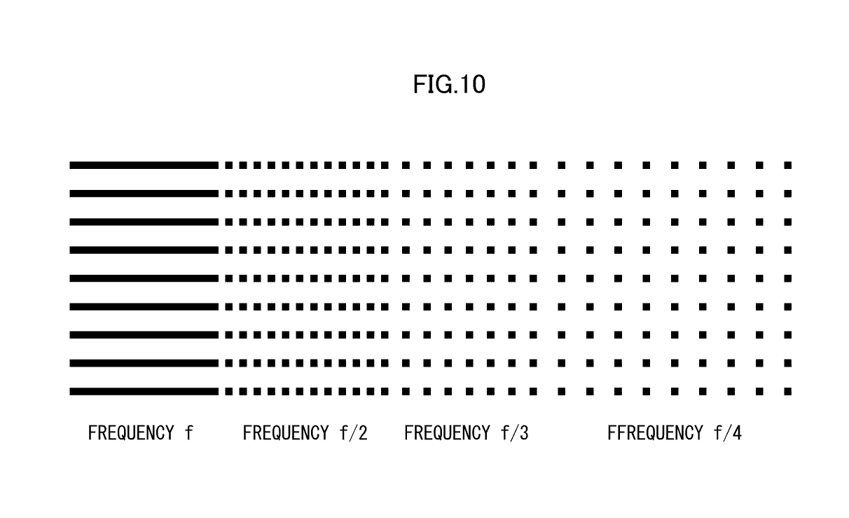

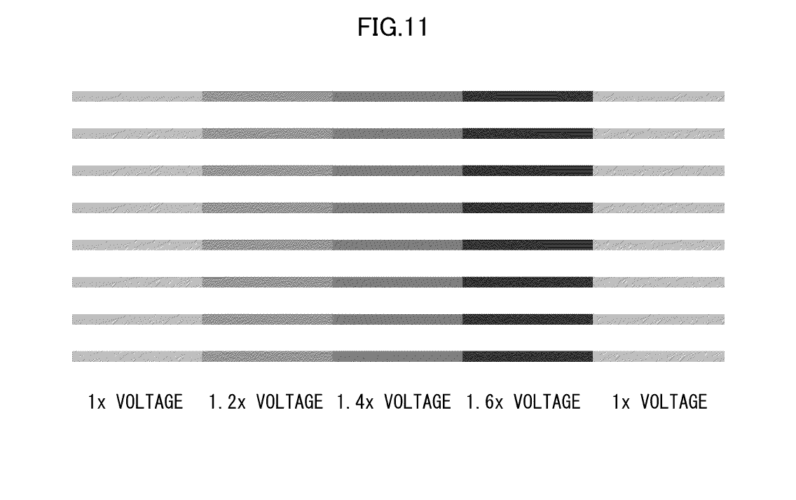

FIG. 9 is a drawing for describing an example in which the drive voltage is raised stepwise while printing the line patterns by the respective nozzles. The horizontal direction in FIG. 9 is the paper conveyance direction (the y direction) and the vertical direction is the effective nozzle arrangement direction (the x direction) (the same applies to FIGS. 10 and 11).

FIG. 9 shows a schematic view of the lines which are printed by progressively increasing the voltage stepwise from 1 time to 1.6 times the voltage of the recording waveform (in sequence: 1×→1.2×→1.4×→1.6×). When the voltage is raised, the ejection stability tends to become worse, and therefore it is desirable to use the start portion of the line where normal ejection is expected (the portion formed by the ejection with the 1× waveform voltage) for detecting defective nozzles (or for measuring deposition position error or droplet volume error, or the like). The droplet ejection portions having raised voltage (the ejection portions with the 1.2× to 1.6× waveform voltages) principally contribute to suppressing blockages.

### Second Modification of Test Pattern

A nozzle suffering an ejection defect can be expected to have increased viscosity of the ink, and therefore the frequency at which stable ejection is possible can be expected to vary. Hence, a desirable mode is one where ejection is performed while varying the ejection frequency stepwise during printing of the test pattern. FIG. 10 is a drawing for describing an example of this.

FIG. 10 shows a schematic view of an example where the frequency is changed stepwise from 1 time, 1/2 times, 1/3 times, to 1/4 times the reference frequency f for recording. By using a print pattern of this kind, it is possible to perform droplet ejection while varying the ejection frequency. It is also possible to adjust the ejection frequency on the apparatus side, by changing the paper conveyance speed, changing the drive signal, or the like; however, it is possible to change the ejection frequency simply, by using data such the image data for the print pattern as in FIG. 10.

### Third Modification of Test Pattern

When the voltage or frequency is changed in printing the test pattern as illustrated in FIG. 9 or 10, it is possible to check the ejection status after the ejection for promoting restoration, by finally printing lines using the normal waveform and normal ejection frequency (reference frequency f) (see FIG. 11). FIG. 11 shows a case where lines produced by ejection with the normal waveform (recording waveform) are added at the ends of the lines in FIG. 9. In this way, by adding the normal waveform at the end, it is possible to confirm the status immediately after printing, and actual printing can be started after confirming the state of restoration of the head.

Although not shown in the drawings, in the example in FIG. 10, it is possible to add lines formed by ejection with the reference frequency f, at the end (after the lines formed by ejection with the 1/4 times frequency).

### Selective Ejection for Promoting Restoration in Relation to Defective Nozzles

As described with reference to FIGS. 7 and 8, it is desirable that the ejection having the even stronger restoration promoting effect is performed in respect only of the nozzles in which ejection defects have been detected. In general, when a strong voltage or waveform is applied, the possibility of infiltration of air bubbles and the occurrence of overflowing is raised. However, by performing driving in this way only in respect of the nozzles which are judged to have ejection defects, it is possible to minimize the negative factors such as infiltration of air bubbles and the occurrence of overflowing.

### Second Embodiment of Control of Printing Operation in Inkjet Recording Apparatus

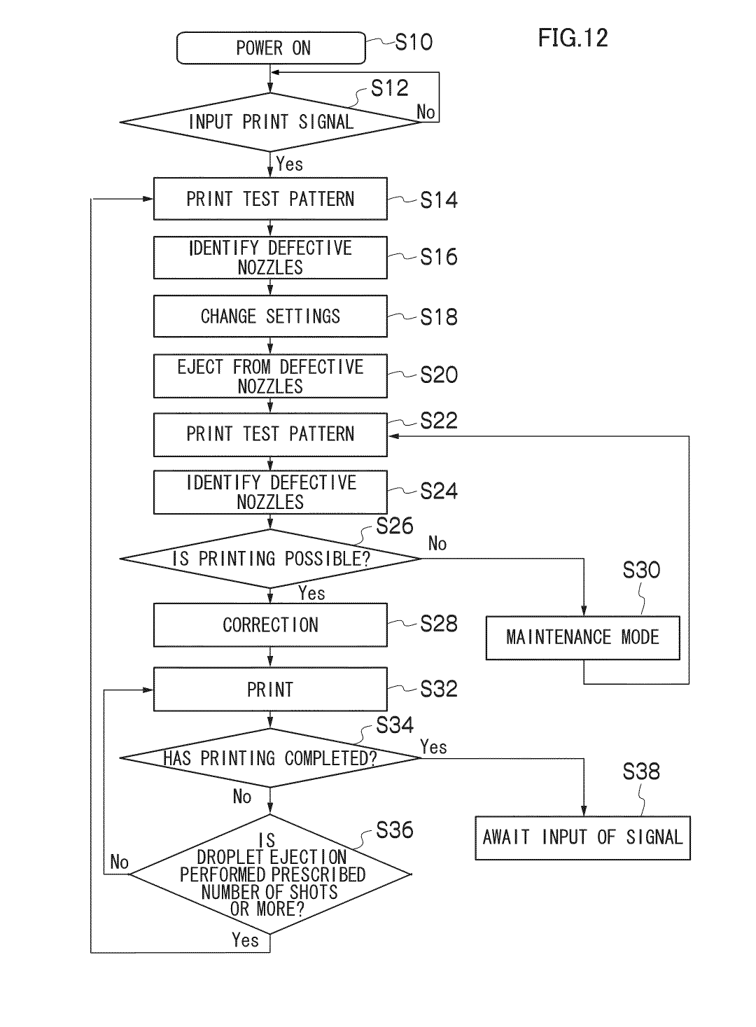

When the defective ejection nozzles have been restored, it is possible for these nozzles to be used again for printing. When the restored nozzles are used for printing, desirably, a test pattern is formed again and it is checked whether the nozzles can be used. FIG. 12 shows an example of this.

FIG. 12 is a flowchart showing a further example of control of a printing operation in an inkjet recording apparatus according to an embodiment of the present invention. In FIG. 12, the steps which are the same as or similar to those in FIG. 8 are denoted with the same step numbers and description thereof is omitted here.

In the example in FIG. 12, after ejection from the defective nozzles in step S20, the procedure advances to step S22 and a test pattern is output again. The ejection conditions in this case may be the same as, or different to, the first time in step S14. For example, in step S22, it is possible to omit the ejection portion for promoting restoration.

Thereupon, defective nozzles are identified by reading out the printed test pattern formed at step S22 (step S24). It is judged whether or not printing is possible, on the basis of this defective nozzle information (step S26). For example, it is judged whether or not the number of defective nozzles is not smaller than a prescribed reference value, and if the number of defective nozzles is not smaller than the reference value, then it is judged that printing is not possible, whereas if the number is smaller than the reference value, then it is judged that printing is possible.

If it is judged that printing is possible at step S26, then the procedure advances to step S28, and correction processing is carried out to compensate for the droplet ejection of defective nozzles by means of droplet ejection from other normally functioning nozzles (step S28), and printing is performed on the basis of the corrected data (step S32). There are no particular restrictions on the correction method and it is possible to employ various commonly known ejection failure correction technologies. General ejection failure correction technology corrects the values (image setting values representing density tone graduations) of pixels corresponding to the nozzles which are adjacent before and after the non-ejecting nozzles (before and after the non-ejecting nozzles in the alignment sequence of the effective nozzle row). The nozzles identified as defective nozzles are compulsorily disabled for ejection (an ejection instruction is not applied), and the output density is covered by droplet ejection from other, peripherally located, nozzles.

On the other hand, if it is judged that printing is impossible at step S26, then the apparatus switches to maintenance mode in step S30. This maintenance mode involves withdrawing the head to outside the region of the paper and performing maintenance, such as application of pressure to the head, nozzle suction, wiping, or the like, in a maintenance station.

When the maintenance in step S30 has been completed, the procedure returns to step S22.

According to the mode shown in FIG. 12, by means of the steps in S14 and S18 to S22, effects in preventing blockages and restoring nozzles are obtained, and therefore it is possible to reduce the number of times that the apparatus transfers to maintenance mode (in step S30).

### Waveform for Promoting Restoration (Preventing Blockages)

The waveform applied when printing a test pattern in step S14 and ejecting from defective nozzles in step S20 desirably employs a waveform having good ejection efficiency, such as a rectangular wave that is repeated at the intrinsic period of the head (the Helmholtz intrinsic vibration period Tc).

### Embodiment of Composition of Inkjet Recording Apparatus

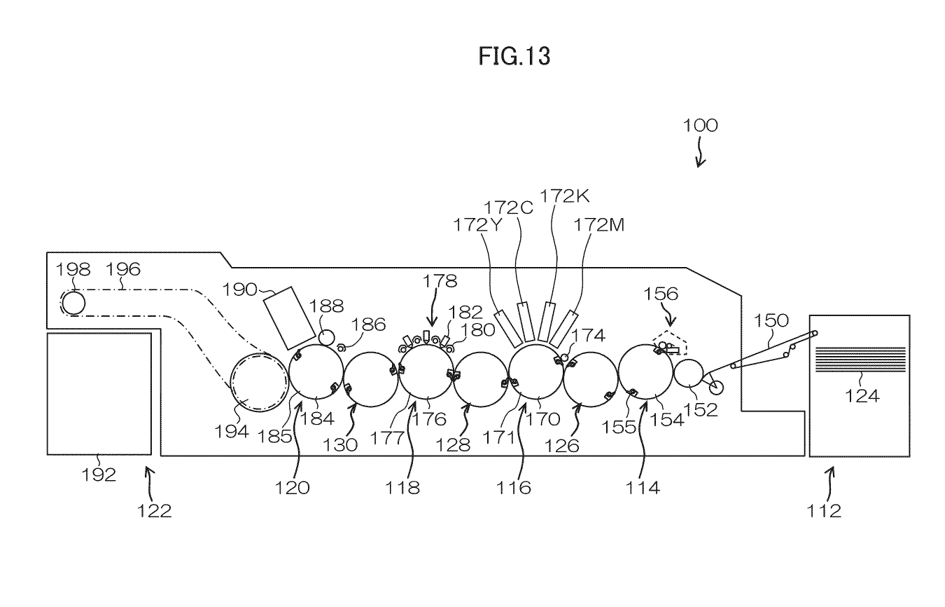

FIG. 13 is a schematic view of the composition of an inkjet recording apparatus according to an embodiment of the present invention. This inkjet recording apparatus 100 uses a pressure drum direct image formation method, which forms a desired color image by ejecting droplets of inks of a plurality of colors from inkjet heads 172M, 172K, 172C and 172Y onto a recording medium 124 (corresponding to a “recording medium”, hereinafter also referred to as “paper” for the sake of convenience) held on a pressure drum (image formation drum 170) of an image formation unit 116. The inkjet recording apparatus 100 is an image forming apparatus of an on-demand type employing a two-liquid reaction (aggregation) method in which an image is formed on a recording medium 124 by depositing a treatment liquid (here, an aggregating treatment liquid) on the recording medium 124 before ejecting droplets of ink, and causing the treatment liquid and ink liquid to react together.

As shown in FIG. 13, the inkjet recording apparatus 100 includes a paper supply unit 112, a treatment liquid deposition unit 114, the image formation unit 116, a drying unit 118, a fixing unit 120 and a paper output unit 122.

### <Paper Supply Unit>

The paper supply unit 112 is a mechanism for supplying the recording medium 124 to the treatment liquid deposition unit 114. The recording media 124, which are cut sheets of paper, are stacked in the paper supply unit 112. The paper supply unit 112 is provided with a paper supply tray 150, and the recording medium 124 is supplied one sheet at a time to the treatment liquid deposition unit 114 from the paper supply tray 150.

In the inkjet recording apparatus 100 according to the present embodiment, it is possible to use recording media 124 of a plurality of types having different materials and/or dimensions (paper sizes). It is also possible to use a mode in which a plurality of paper trays (not shown) for respectively and separately stacking recording media of different types are arranged in the paper supply unit 112, and the paper supplied from the paper supply tray 150 amongst this plurality of paper trays is switched automatically, or a mode in which the operator selects the paper tray or replaces the paper tray according to requirements. In the present embodiment, cut sheet paper (cut paper) is used as the recording medium 124, but it is also possible to adopt a composition in which paper is supplied from a continuous roll (rolled paper) and is cut to the required size.

### <Treatment Liquid Deposition Unit>

The treatment liquid deposition unit 114 is a mechanism which deposits the treatment liquid onto a recording surface of the recording medium 124. The treatment liquid includes a coloring material aggregating agent which aggregates the coloring material (in the present embodiment, the pigment) in the ink deposited by the image formation unit 116, and the separation of the ink into the coloring material and the solvent is promoted due to the treatment liquid and the ink making contact with each other.

As shown in FIG. 13, the treatment liquid deposition unit 114 includes a paper supply drum 152, a treatment liquid drum 154 and a treatment liquid application device 156. The treatment liquid drum 154 holds the recording medium 124 and conveys the recording medium 124 so as to rotate. The treatment liquid drum 154 includes a hook-shaped gripping device (gripper) 155 arranged on the outer circumferential surface thereof, and is devised in such a manner that the leading end of the recording medium 124 can be held by gripping the recording medium 124 between the hook of the holding device 155 and the circumferential surface of the treatment liquid drum 154. The treatment liquid drum 154 can have suction holes arranged in the outer circumferential surface thereof, and be connected to a suction device which performs suction through the suction holes. By this means, it is possible to hold the recording medium 124 tightly against the circumferential surface of the treatment liquid drum 154.

The treatment liquid application device 156 is arranged opposing the circumferential surface of the treatment liquid drum 154, to the outside of the drum. The treatment liquid application device 156 includes: a treatment liquid vessel, in which the treatment liquid is stored; an anilox roller, which is partially immersed in the treatment liquid in the treatment liquid vessel; and a rubber roller, which transfers a dosed amount of the treatment liquid to the recording medium 124, by being pressed against the anilox roller and the recording medium 124 on the treatment liquid drum 154. According to this treatment liquid application device 156, it is possible to apply the treatment liquid to the recording medium 124 while dosing the amount of the treatment liquid.

In the present embodiment, a composition is described which uses the roller-based application method; however, the method is not limited to this, and it is also possible to employ various other methods, such as a spray method, an inkjet method, or the like.

The recording medium 124 onto which the treatment liquid has been deposited by the treatment liquid deposition unit 114 is transferred from the treatment liquid drum 154 to the image formation drum 170 of the image formation unit 116 through an intermediate conveyance unit 126.

### <Image Formation Unit>

The image formation unit 116 includes the image formation drum 170, a paper pressing roller 174, and the inkjet heads 172M, 172K, 172C and 172Y (corresponding to “recording heads”). Similarly to the treatment liquid drum 154, the image formation drum 170 has a hook-shaped holding device (gripper) 171 on the outer circumferential surface of the drum. The recording medium 124 held on the image formation drum 170 is conveyed with the recording surface thereof facing to the outer side, and ink is deposited onto this recording surface from the inkjet heads 172M, 172K, 172C and 172Y.

The inkjet heads 172M, 172K, 172C and 172Y are each full-line type inkjet recording heads having a length corresponding to the maximum width of the image forming region on the recording medium 124, and rows of nozzles for ejecting the ink arranged throughout the whole width of the image forming region is formed in the ink ejection surface of each head. The inkjet heads 172M, 172K, 172Y and 172Y are disposed so as to extend in a direction perpendicular to the conveyance direction of the recording medium 124 (the direction of rotation of the image formation drum 170).

When droplets of the corresponding colored ink are ejected from the inkjet heads 172M, 172K, 172C and 172Y toward the recording surface of the recording medium 124 which is held tightly on the image formation drum 170, the ink makes contact with the treatment liquid which has previously been deposited on the recording surface by the treatment liquid deposition unit 114, the coloring material (pigment) dispersed in the ink is aggregated, and a coloring material aggregate is thereby formed. By this means, flowing of coloring material, and the like, on the recording medium 124 is prevented and an image is formed on the recording surface of the recording medium 124.

Thus, the recording medium 124 is conveyed at a uniform speed by the image formation drum 170, and it is possible to record an image on an image forming region of the recording medium 124 by performing just one operation of moving the recording medium 124 and the respective inkjet heads 172M, 172K, 172C and 172Y relatively in the conveyance direction (in other words, by a single sub-scanning operation). This single-pass type image formation with such the full line type (page-wide) head can achieve a higher printing speed compared with a case of a multi-pass type image formation with a serial (shuttle) type of head which moves back and forth reciprocally in the direction (the main scanning direction) perpendicular to the conveyance direction of the recording medium (sub-scanning direction), and hence it is possible to improve the print productivity.

The inkjet recording apparatus 100 in the present embodiment is able to record on recording media (recording paper) up to a maximum size of 720 mm×520 mm, and a drum having a diameter of 500 mm corresponding to the recording medium width of 720 mm is used for the image formation drum 170. The ink droplet ejection volume of the inkjet heads 172M, 172K, 172C and 172Y is 2 pl, for example, and the recording density is 1200 dpi in both the main scanning direction (the widthwise direction of the recording medium 124) and the sub-scanning direction (the conveyance direction of the recording medium 124).

Although the configuration with the CMYK standard four colors is described in the present embodiment, combinations of the ink colors and the number of colors are not limited to those. As required, light inks, dark inks and/or special color inks can be added. For example, a configuration in which inkjet heads for ejecting light-colored inks such as light cyan and light magenta are added is possible. Moreover, there are no particular restrictions of the sequence in which the heads of respective colors are arranged.

The recording medium 124 onto which an image has been formed in the image formation unit 116 is transferred from the image formation drum 170 to a drying drum 176 of the drying unit 118 through an intermediate conveyance unit 128.

### <Drying Unit>

The drying unit 118 is a mechanism which dries the water content contained in the solvent which has been separated by the action of aggregating the coloring material, and as shown in FIG. 13, includes the drying drum 176 and a solvent drying device 178.

Similarly to the treatment liquid drum 154, the drying drum 176 has a hook-shaped holding device (gripper) 177 arranged on the outer circumferential surface of the drum, in such a manner that the leading end of the recording medium 124 can be held by the holding device 177.

The solvent drying device 178 is disposed in a position opposing the outer circumferential surface of the drying drum 176, and is constituted of a plurality of halogen heaters 180 and hot air spraying nozzles 182 disposed respectively between the halogen heaters 180.

It is possible to achieve various drying conditions, by suitably adjusting the temperature and air flow volume of the hot air flow which is blown from the hot air flow spraying nozzles 182 toward the recording medium 124, and the temperatures of the respective halogen heaters 180.

Furthermore, the surface temperature of the drying drum 176 is set to not lower than 50° C. By heating from the rear surface of the recording medium 124, drying is promoted and breaking of the image during fixing can be prevented. There are no particular restrictions on the upper limit of the surface temperature of the drying drum 176, but from the viewpoint of the safety of maintenance operations such as cleaning the ink adhering to the surface of the drying drum 176, desirably, the surface temperature of the drying drum 176 is not higher than 75° C. (and more desirably, not higher than 60° C.).

By holding the recording medium 124 in such a manner that the recording surface thereof is facing outward on the outer circumferential surface of the drying drum 176 (in other words, in a state where the recording surface of the recording medium 124 is curved in a convex shape), and drying while conveying the recording medium in rotation, it is possible to prevent the occurrence of wrinkles or floating up of the recording medium 124, and therefore drying non-uniformities caused by these phenomena can be prevented reliably.

The recording medium 124 on which the drying process has been carried out in the drying unit 118 is transferred from the drying drum 176 to a fixing drum 184 of the fixing unit 120 through an intermediate conveyance unit 130.

### <Fixing Unit>

The fixing unit 120 includes the fixing drum 184, a halogen heater 186, a fixing roller 188 and an in-line sensor 190. Similarly to the treatment liquid drum 154, the fixing drum 184 has a hook-shaped holding device (gripper) 185 arranged on the outer circumferential surface of the drum, in such a manner that the leading end of the recording medium 124 can be held by the holding device 185.

By means of the rotation of the fixing drum 184, the recording medium 124 is conveyed with the recording surface facing to the outer side, and preliminary heating by the halogen heater 186, a fixing process by the fixing roller 188 and inspection by the in-line sensor 190 (corresponding to an “image reading device”) are carried out in respect of the recording surface.

The halogen heater 186 is controlled to a prescribed temperature (for example, 180° C.). By this means, preliminary heating of the recording medium 124 is carried out.

The fixing roller 188 is a roller member for melting self-dispersing polymer micro-particles contained in the ink and thereby causing the ink to form a film, by applying heat and pressure to the dried ink, and is composed so as to apply heat and pressure to the recording medium 124. More specifically, the fixing roller 188 is disposed so as to press against the fixing drum 184, in such a manner that a nip is created between the fixing roller and the fixing drum 184. By this means, the recording medium 124 is placed between the fixing roller 188 and the fixing drum 184 and is nipped with a prescribed nip pressure (for example, 0.15 MPa), whereby a fixing process is carried out.

Furthermore, the fixing roller 188 is constituted of a heated roller formed by a metal pipe of aluminum, or the like, having good thermal conductivity, which internally incorporates a halogen lamp, and is controlled to a prescribed temperature (for example, 60° C. to 80° C.). By heating the recording medium 124 by means of this heating roller, thermal energy to reach the temperature higher than the Tg temperature (glass transition temperature) of the latex contained in the ink is applied and the latex particles are thereby caused to melt. By this means, fixing is performed by pressing the latex particles into the undulations in the recording medium 124, as well as leveling the undulations in the image surface and obtaining a glossy finish.

In the embodiment shown in FIG. 13, only one fixing roller 188 is arranged; however, it is also possible to provide fixing rollers in a plurality of stages, in accordance with the thickness of the image layer and the Tg characteristics of the latex particles.

On the other hand, the in-line sensor 190 is a device for reading in an image (test pattern or actual image) recorded on the recording medium 124, and employs a CCD line sensor, or the like.

According to the fixing unit 120 having the composition described above, the latex particles in the thin image layer formed by the drying unit 118 are heated, pressed and melted by the fixing roller 188, and hence the image layer can be fixed to the recording medium 124. Moreover, the surface temperature of the fixing drum 184 is set to not lower than 50° C. Drying is promoted by heating the recording medium 124 held on the outer circumferential surface of the fixing drum 184 from the rear surface, and therefore breaking of the image during fixing can be prevented, and furthermore, the strength of the image can be increased by the effects of the increased temperature of the image.

Instead of the ink which contains a high-boiling-point solvent and polymer micro-particles (thermoplastic resin particles), it is also possible to use ink containing a monomer which can be polymerized and cured by exposure to UV light. In this case, the inkjet recording apparatus 100 includes a UV exposure unit for exposing the ink on the recording medium 124 to UV light, instead of the heat and pressure fixing unit (fixing roller 188) using the heat roller. In this way, if using an ink containing an active light-curable resin, such as an ultraviolet-curable resin, a device which irradiates the active light, such as a UV lamp or an ultraviolet LD (laser diode) array, is arranged instead of the fixing roller 188 for heat fixing.

### <Paper Output Unit>

As shown in FIG. 13, the paper output unit 122 is arranged subsequently to the fixing unit 120. The paper output unit 122 includes an output tray 192, and a transfer drum 194. A conveyance belt 196 and a tensioning roller 198 are arranged between the output tray 192 and the fixing drum 184 of the fixing unit 120 so as to oppose same. The recording medium 124 is sent to the conveyance belt 196 by the transfer drum 194 and output to the output tray 192. The details of the paper conveyance mechanism formed by the conveyance belt 196 are not shown, but the leading end portion of the recording medium 124 after printing is held by a gripper on a bar (not shown) which spans between endless conveyance belts 196, and the recording medium is conveyed about the output tray 192 due to the rotation of the conveyance belts 196.

Furthermore, although not shown in FIG. 13, the inkjet recording apparatus 100 according to the present embodiment includes, in addition to the composition described above: an ink storing and loading unit, which supplies the ink to the inkjet heads 172M, 172K, 172C and 172Y; a device which supplies the treatment liquid to the treatment liquid deposition unit 114; the head maintenance unit (maintenance station), which carries out cleaning (nozzle surface wiping, purging, nozzle suctioning, and the like) of the inkjet heads 172M, 172K, 172C and 172Y; position determination sensors which determine the position of the recording medium 124 in the paper conveyance path; temperature sensors, which determine the temperature of the respective units of the apparatus, and the like.

### <Structure of Head>

Next, the structure of the heads is described. The respective heads 170M, 172K, 172C and 172Y have the same structure, and any of the heads is hereinafter denoted with a reference numeral 250.

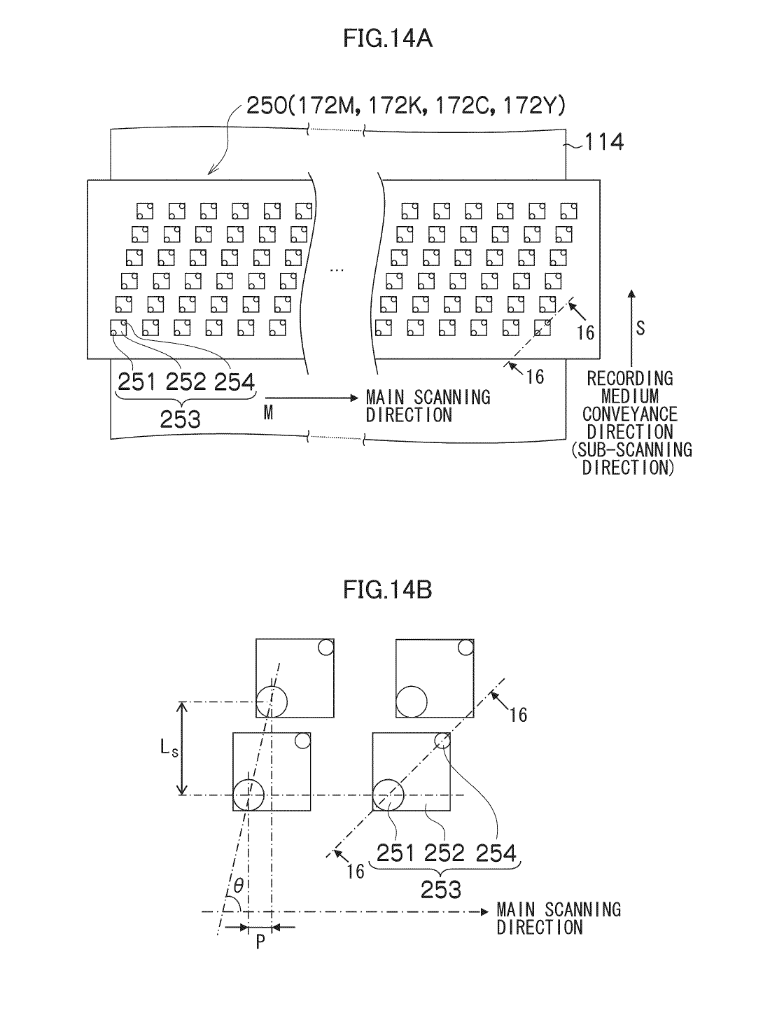

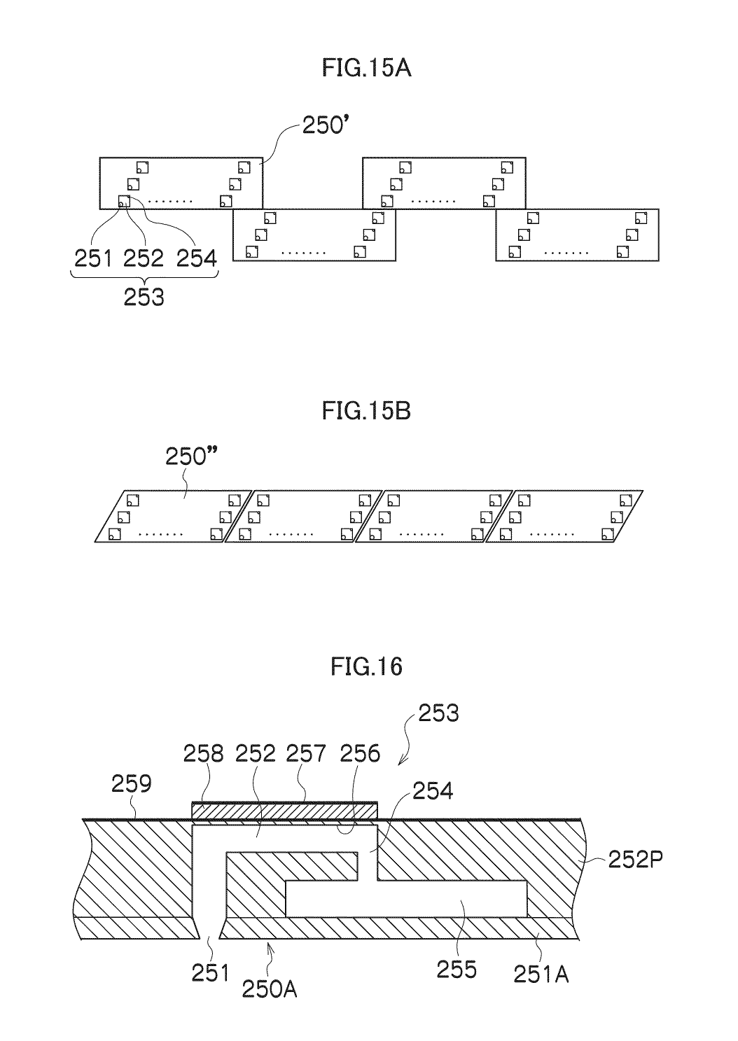

FIG. 14A is a plan perspective diagram illustrating an embodiment of the structure of the head 250, and FIG. 14B is a partial enlarged diagram of same. FIGS. 15A and 14B are planar perspective views illustrating other structural embodiments of heads 250. FIG. 16 is a cross-sectional diagram along line 16-16 in FIGS. 14A and 14B, and illustrates a liquid droplet ejection element for one channel being a recording element unit (an ink chamber unit corresponding to one nozzle 251).

As illustrated in FIGS. 14A and 14B, the head 250 according to the present embodiment has a structure in which a plurality of ink chamber units (liquid droplet ejection elements) 253, each of which has a nozzle 251 forming an ink droplet ejection aperture, a pressure chamber 252 corresponding to the nozzle 251, and the like, are disposed two-dimensionally in the form of a staggered matrix, and hence the effective nozzle interval (the projected nozzle pitch) as projected (orthographically-projected) in the lengthwise direction of the head (the direction perpendicular to the paper conveyance direction) is reduced and high nozzle density is achieved.

The mode of forming nozzle rows which have a length not shorter than the entire width Wm of the recording area of the recording medium 124 in a direction (direction indicated by arrow M: main scanning direction) substantially perpendicular to the paper conveyance direction (direction indicated by arrow S: sub-scanning direction) of the recording medium 124 is not limited to the embodiment described above. For example, instead of the configuration in FIG. 14A, as illustrated in FIG. 15A, a line head having nozzle rows of a length corresponding to the entire width Win of the recording area of the recording medium 124 can be formed by arranging and combining, in a staggered matrix, short head modules 250′ having a plurality of nozzles 251 arrayed in a two-dimensional fashion. It is also possible to arrange and combine short head modules 250″ in a line as shown in FIG. 15B.

The pressure chamber 252 provided to each nozzle 251 has substantially a square planar shape (see FIGS. 14A and 14B), and has an outlet port for the nozzle 251 at one of diagonally opposite corners and an inlet port (supply port) 254 for receiving the supply of the ink at the other of the corners. The planar shape of the pressure chamber 252 is not limited to this embodiment and can be various shapes including quadrangle (rhombus, rectangle, etc.), pentagon, hexagon, other polygons, circle, and ellipse.

As illustrated in FIG. 16, the head 250 is configured by stacking and joining together a nozzle plate 251A, in which the nozzles 251 are formed, a flow channel plate 252P, in which the pressure chambers 252 and flow channels including a common flow channel 255 are formed, and the like. The nozzle plate 251A constitutes a nozzle surface (ink ejection surface) 250A of the head 250 and has formed therein the two-dimensionally arranged nozzles 251 communicating respectively to the pressure chambers 252.

The flow channel plate 252P constitutes lateral side wall parts of the pressure chamber 252 and serves as a flow channel formation member, which forms the supply port 254 as a limiting part (the narrowest part) of the individual supply channel leading the ink from the common flow channel 255 to the pressure chamber 252. FIG. 16 is simplified for the convenience of explanation, and the flow channel plate 252P can be structured by stacking one or more substrates.

The nozzle plate 251A and the flow channel plate 252P can be made of silicon and formed in the prescribed shapes by means of the semiconductor manufacturing process.

The common flow channel 255 is connected to an ink tank (not shown), which is a base tank for supplying ink, and the ink supplied from the ink tank is delivered through the common flow channel 255 to the pressure chambers 252.

A piezoelectric actuator 258 having an individual electrode 257 is bonded on a diaphragm 256 constituting a part of faces (the ceiling face in FIG. 16) of the pressure chamber 252. The diaphragm 256 in the present embodiment is made of silicon having a nickel (Ni) conductive layer serving as a common electrode 259 corresponding to the lower electrodes of the piezoelectric actuators 258, and serves as the common electrode of the piezoelectric actuators 258, which are disposed on the respective pressure chambers 252. The diaphragm 256 can be formed by a non-conductive material such as resin; and in this case, a common electrode layer made of a conductive material such as metal is formed on the surface of the diaphragm member. It is also possible that the diaphragm is made of metal (an electrically-conductive material) such as stainless steel (SUS), which also serves as the common electrode.

When a drive voltage is applied between the individual electrode 257 and the common electrode 259, the piezoelectric actuator 258 is deformed, the volume of the pressure chamber 252 is thereby changed, and the pressure in the pressure chamber 252 is thereby changed, so that the ink inside the pressure chamber 252 is ejected through the nozzle 251. When the displacement of the piezoelectric actuator 258 is returned to its original state after the ink is ejected, new ink is refilled in the pressure chamber 252 from the common flow channel 255 through the supply port 254.

As illustrated in FIG. 14B, the plurality of ink chamber units 253 having the above-described structure are arranged in a prescribed matrix arrangement pattern in a line direction along the main scanning direction and a column direction oblique at an angle of θ with respect to the main scanning direction, and thereby the high density nozzle head is formed in the present embodiment. In this matrix arrangement, the nozzles 251 can be regarded to be equivalent to those substantially arranged linearly at a fixed pitch P=Ls/tan θ along the main scanning direction, where Ls is a distance between the nozzles adjacent in the sub-scanning direction.

In implementing the present invention, the mode of arrangement of the nozzles 251 in the head 250 is not limited to the embodiments in the drawings, and various nozzle arrangement structures can be employed. For example, instead of the matrix arrangement as described in FIGS. 14A and 14B, it is also possible to use a single linear arrangement, a V-shaped nozzle arrangement, or an undulating nozzle arrangement, such as zigzag configuration (W-shape arrangement), which repeats units of V-shaped nozzle arrangements.

The devices which generate pressure (ejection energy) applied to eject droplets from the nozzles in the inkjet head are not limited to the piezoelectric actuators (piezoelectric elements), and can employ various pressure generation devices (energy generation devices), such as heaters in a thermal system (which uses the pressure resulting from film boiling by the heat of the heaters to eject ink) and various actuators in other systems. According to the ejection system employed in the head, the corresponding energy generation devices are arranged in the flow channel structure body.

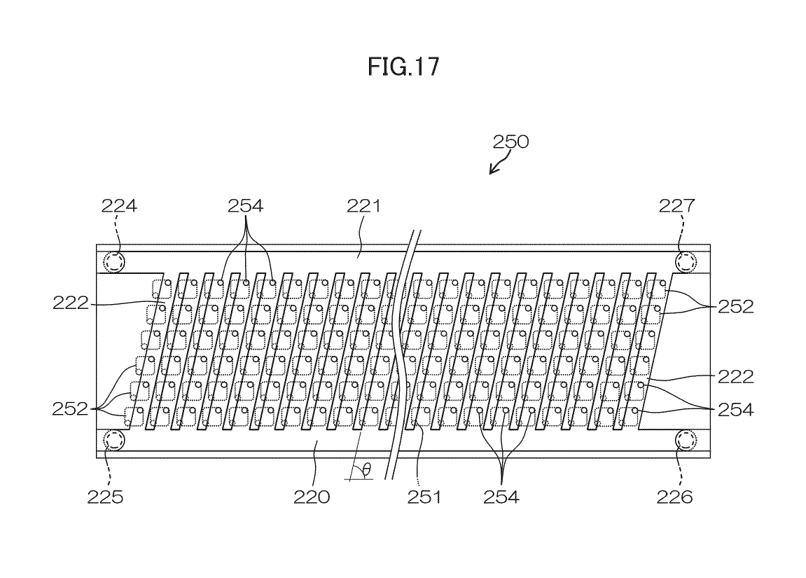

FIG. 17 is a plan diagram showing the flow channel structure inside the head 250. As shown in FIG. 17, the head 250 has a flow channel structure for ink supply including main flow channels 220, 221, branch flow channels 222, ink inlet ports (trunk supply ports) 224 to 227, and the like. The branch flow channels 222 in FIG. 17 correspond to the common flow channel indicated by reference numeral 255 in FIG. 16.

As shown in FIG. 17, the branch flow channels 222 are arranged in line with the arrangement of respective pressure chambers 252 which are aligned in a direction at an angle of θ, and are connected with the upper and lower main flow channels 220 and 221. Therefore, the branch flow channels 222 are arranged so as to pass in a ladder shaped configuration between the main flow channels 220 and 221. Furthermore, the supply ports 254 of the pressure chambers 252 are connected to the branch flow channels 222. More specifically, the branch flow channel 222 is provided for each nozzle row group (here, 6 nozzles are depicted by way of example) which are arranged in a direction at the angle of θ in FIG. 17. If nozzles which are connected to the same branch flow channel 222 (in the present example, there are 6 such nozzles) perform ejection simultaneously, then there is a possibility of effects due to cross-talk, and therefore in printing a test pattern, it is desirable to control printing in such a manner that nozzles which receive a supply of ink from the same branch flow channel 222 are not simultaneously driven.

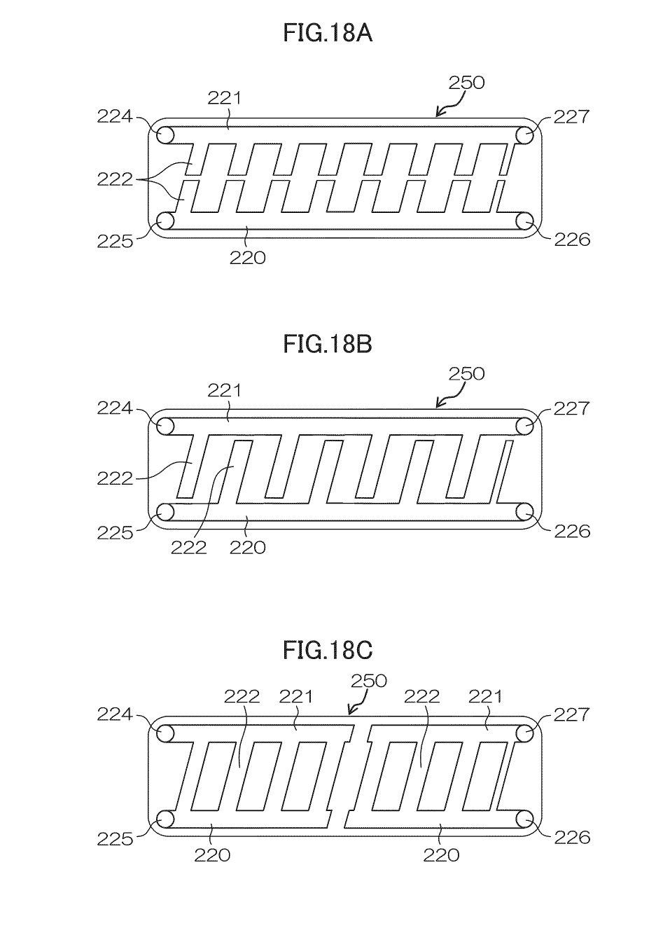

The structure of the flow channels inside the head is not limited to the embodiment in FIG. 17 and further embodiments are depicted in FIGS. 18A, 18B and 18C. In FIGS. 18A to 18C, elements which are the same as or similar to the embodiment in FIG. 17 are denoted with the same reference numerals and further explanation thereof is omitted here.

### <Description of Control System>

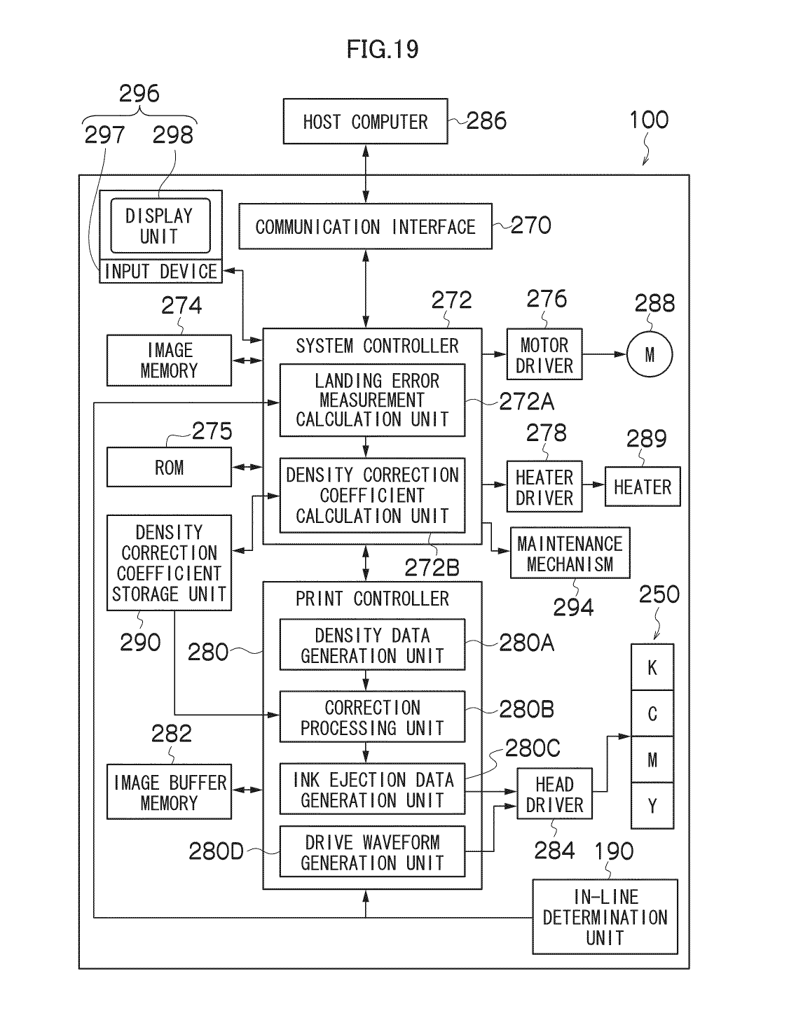

FIG. 19 is a block diagram showing the system configuration of the inkjet recording apparatus 100. As shown in FIG. 19, the inkjet recording apparatus 100 includes a communication interface 270, a system controller 272, an image memory 274, a ROM 275, a motor driver 276, a heater driver 278, a print controller 280, an image buffer memory 282, a head driver 284, and the like.

The communication interface 270 is an interface unit (image input device) for receiving image data sent from a host computer 286. A serial interface such as USB (Universal Serial Bus), IEEE1394, Ethernet, and wireless network, or a parallel interface such as a Centronics interface may be used as the communication interface 270. A buffer memory (not shown) may be mounted in this portion in order to increase the communication speed.

The image data sent from the host computer 286 is received by the inkjet recording apparatus 100 through the communication interface 270, and is temporarily stored in the image memory 274. The image memory 274 is a storage device for storing images inputted through the communication interface 270, and data is written and read to and from the image memory 274 through the system controller 272. The image memory 274 is not limited to a memory composed of semiconductor elements, and a hard disk drive or another magnetic medium may be used.

The system controller 272 is constituted of a central processing unit (CPU) and peripheral circuits thereof, and the like, and it functions as a control device for controlling the whole of the inkjet recording apparatus 100 in accordance with a prescribed program, as well as a calculation device for performing various calculations. More specifically, the system controller 272 controls the various sections, such as the communication interface 270, image memory 274, motor driver 276, heater driver 278, and the like, as well as controlling communications with the host computer 286 and writing and reading to and from the image memory 274 and the ROM 275, and it also generates control signals for controlling the motor 288 and heater 289 of the conveyance system.

Furthermore, the system controller 272 includes a depositing error measurement and calculation unit 272A, which performs calculation processing for generating data indicating the positions of defective nozzles, depositing position error data, data indicating the density distribution (density data) and other data from the data read in from the test chart by the in-line sensor (in-line determination unit) 190, and a density correction coefficient calculation unit 272B, which calculates density correction coefficients from the information relating to the measured depositing position error and the density information. The processing functions of the depositing error measurement and calculation unit 272A and the density correction coefficient calculation unit 272B can be achieved by means of an ASIC (application specific integrated circuit), software, or a suitable combination of same.

The density correction coefficient data obtained by the density correction coefficient calculation unit 272B is stored in a density correction coefficient storage unit 290.

The program executed by the CPU of the system controller 272 and the various types of data (including data for deposition to form the test pattern, waveform data for printing test patterns, waveform data for the image recording, data of defective nozzles, and the like) which are required for control procedures are stored in the ROM 275. The ROM 275 may be a non-writeable storage device, or it may be a rewriteable storage device, such as an EEPROM. By utilizing the storage region of this ROM 275, the ROM 275 can be configured to be able to serve also as the density correction coefficient storage unit 290.

The image memory 274 is used as a temporary storage region for the image data, and it is also used as a program development region and a calculation work region for the CPU.

The motor driver (drive circuit) 276 drives the motor 288 of the conveyance system in accordance with commands from the system controller 272. The heater driver (drive circuit) 278 drives the heater 289 of the drying unit 118 or the like in accordance with commands from the system controller 272.

The print controller 280 is a control unit which functions as a signal processing device for performing various treatment processes, corrections, and the like, in accordance with the control implemented by the system controller 272, in order to generate a signal for controlling droplet ejection from the image data (multiple-value input image data) in the image memory 274, as well as functioning as a drive control device which controls the ejection driving of the head 250 by supplying the ink ejection data thus generated to the head driver 284.

The print controller 280 includes a density data generation unit 280A, a correction processing unit 280B, an ink ejection data generation unit 280C and a drive waveform generation unit 280D. These functional units (280A to 280D) can be realized by means of an ASIC, software or a suitable combination of same.

The density data generation unit 280A is a signal processing device which generates initial density data for the respective ink colors, from the input image data, and it carries out density conversion processing (including UCR processing and color conversion) and, where necessary, it also performs pixel number conversion processing.

The correction processing unit 280B is a processing device which performs density correction calculations using the density correction coefficients stored in the density correction coefficient storage unit 290, and it carries out the non-uniformity correction processing.

The ink ejection data generation unit 280C is a signal processing device including a halftoning device which converts the corrected image data (density data) generated by the correction processing unit 280B into binary or multiple-value dot data, and the ink ejection data generation unit 280C carries out binarization (multiple-value conversion) processing.

The ink ejection data generated by the ink ejection data generation unit 280C is supplied to the head driver 284, which controls the ink ejection operation of the head 250 accordingly.

The drive waveform generation unit 280D is a device for generating drive signal waveforms in order to drive the piezoelectric actuators 258 (see FIG. 16) corresponding to the respective nozzles 251 of the head 250. The signal (drive waveform) generated by the drive waveform generation unit 280D is supplied to the head driver 284. The signal outputted from the drive waveforms generation unit 280D may be digital waveform data, or it may be an analog voltage signal.

The drive waveform generation unit 280D generates selectively the drive signal having the recording waveform and the drive signal having the test pattern printing waveform. The various waveform data is beforehand stored in the ROM 275, and the waveform data to be used is selectively output according to requirements. The inkjet recording apparatus 100 shown in the present embodiment employs a drive method in which a common drive power waveform signal is applied to the piezoelectric actuators 258 of the head 250, and ink is ejected from the nozzles 251 corresponding to the respective piezoelectric actuators 258 by turning switching elements (not illustrated) connected to the individual electrodes of the piezoelectric actuators 258 on and off, in accordance with the ejection timing of the respective piezoelectric actuators 258. The image buffer memory 282 is provided in the print controller 280, and image data, parameters, and other data are temporarily stored in the image buffer memory 282 when image data is processed in the print controller 280. FIG. 19 shows a mode in which the image buffer memory 282 is attached to the print controller 280; however, the image memory 274 may also serve as the image buffer memory 282. Also possible is a mode in which the print controller 280 and the system controller 272 are integrated to form a single processor.

To give a general description of the sequence of processing from image input to print output, image data to be printed (original image data) is inputted from an external source through the communication interface 270, and is accumulated in the image memory 274. At this stage, multiple-value RGB image data is stored in the image memory 274, for example.

In this inkjet recording apparatus 100, an image which appears to have a continuous tonal graduation to the human eye is formed by changing the deposition density and the dot size of fine dots created by ink (coloring material), and therefore, it is necessary to convert the input digital image into a dot pattern which reproduces the tonal graduations of the image (namely, the light and shade toning of the image) as faithfully as possible. Therefore, original image data (RGB data) stored in the image memory 274 is sent to the print controller 280, through the system controller 272, and is converted to the dot data for each ink color by a half-toning technique, using dithering, error diffusion, or the like, by passing through the density data generation unit 280A, the correction processing unit 280B, and the ink ejection data generation unit 280C of the print controller 280.

In other words, the print controller 280 performs processing for converting the input RGB image data into dot data for the four colors of K, C, M and Y. Processing for correcting ejection failure is performed when the processing of conversion to dot data is carried out.

The dot data thus generated by the print controller 280 is stored in the image buffer memory 282. This dot data of the respective colors is converted into CMYK droplet ejection data for ejecting ink from the nozzles of the head 250, thereby establishing the ink ejection data to be printed.

The head driver 284 includes an amplifier circuit and outputs drive signals for driving the piezoelectric actuators 258 corresponding to the nozzles 251 of the head 250 in accordance with the print contents, on the basis of the ink ejection data and the drive waveform signals supplied by the print controller 280. A feedback control system for maintaining constant drive conditions in the head may be included in the head driver 284.

By supplying the drive signals outputted by the head driver 284 to the head 250 in this way, ink is ejected from the corresponding nozzles 251. By controlling ink ejection from the print head 250 in synchronization with the conveyance speed of the recording medium 124, an image is formed on the recording medium 124.

As described above, the ejection volume and the ejection timing of the ink droplets from the respective nozzles are controlled through the head driver 284, on the basis of the ink ejection data generated by implementing prescribed signal processing in the print controller 280, and the drive signal waveform. By this means, prescribed dot size and dot positions can be achieved.

As described with reference to FIG. 13, the in-line sensor (determination unit) 190 is a block including an image sensor, which reads in the image printed on the recording medium 124, performs various signal processing operations, and the like, and determines the print situation (presence/absence of ejection, variation in droplet ejection, optical density, and the like), these determination results being supplied to the print controller 280 and the system controller 272.

The print controller 280 implements various corrections with respect to the head 250, on the basis of the information obtained from the in-line sensor (determination unit) 190, according to requirements, and it implements control for carrying out cleaning operations (nozzle restoring operations), such as preliminary ejection, suctioning, or wiping, as and when necessary.

The maintenance mechanism 294 includes members used to head maintenance operation, such as an ink receptacle, a suction cap, a suction pump, a wiper blade, and the like.

The operating unit 296 which forms a user interface is constituted of an input device 297 through which an operator (user) can make various inputs, and a display unit 298. The input device 297 may employ various formats, such as a keyboard, mouse, touch panel, buttons, or the like. The operator is able to enter print conditions, select image quality modes, enter and edit additional information, search for information, and the like, by operating the input device 297, and is able to check various information, such as the input contents, search results, and the like, through a display on the display unit 298. The display unit 298 also functions as a warning notification device which displays a warning message, or the like.

Furthermore, a combination of the system controller 272 and the print controller 280 corresponds to a “recording ejection control device” and a “test pattern formation control device”.

It is also possible to adopt a mode in which the host computer 286 is equipped with all or a portion of the processing functions carried out by the depositing error measurement and calculation unit 272A, the density correction coefficient calculation unit 272B, the density data generation unit 280A and the correction processing unit 280B as shown in FIG. 19.

### Embodiment of In-Line Sensor (Image Reading Device)

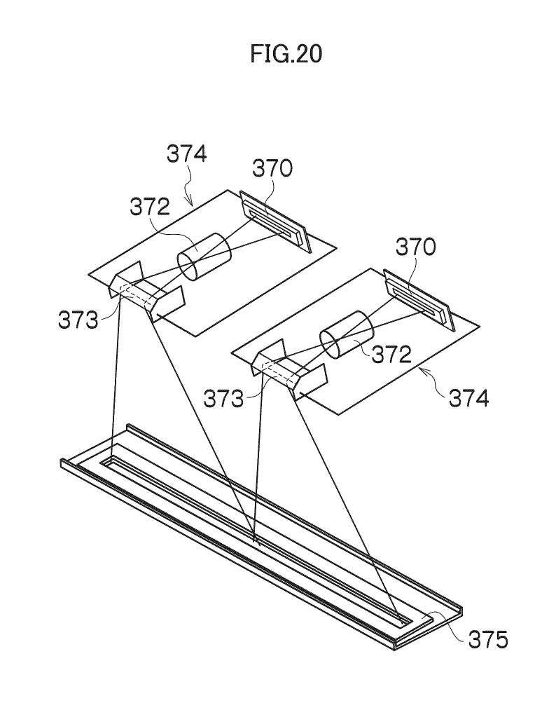

FIG. 20 is a schematic drawing showing the composition of the in-line sensor 190. The in-line sensor 190 includes reading sensor units 374, which are arranged in parallel and read out the image on a recording medium. Each of the reading sensor units 374 is constituted integrally of: a line CCD 370 (corresponding to an “image reading device”); a lens 372, which forms an image on a light receiving surface of the line CCD 370; and a mirror 373, which bends the light path. The line CCD 370 has an array of color-specific photocells (pixels) provided with three-color RGB filters, and is able to read in a color image by means of RGB color separation. For example, next to each photo cell array of 3 RGB lines, there is provided a CCD analog shift register, which respectively and independently transfers the charges of the even-numbered pixels and odd-numbered pixels in one line.

More specifically, it is possible to use a line CCD “μPD8827A” (product name) having a pixel pitch of 9.325 μm, 7600 pixels×RGB, and a device length (width of sensor in direction of arrangement of photocells) of 70.87 mm, manufactured by NEC Electronics Corporation.

The line CCD 370 is fixed in a configuration where the direction of arrangement of the photocells is parallel with the axis of the drum on which the recording medium is conveyed.

The lens 372 is a lens of a condenser optics system, which provides the image on the recording medium that is wrapped about the conveyance drum (indicated by reference numeral 184 in FIG. 13), at a prescribed rate of reduction. For example, if a lens which reduces the image to 0.19 times is employed, then the 373 mm width on the recording medium is provided onto the line CCD 270. In this case, the reading resolution on the recording medium is 518 dpi.

As illustrated in FIG. 20, the reading sensor units 374 each integrally having the line CCD 370, lens 372 and mirror 373 can be moved and adjusted in parallel with the axis of the conveyance drum, whereby the positions of the two reading sensor units 374 are adjusted and the respective reading sensor units 374 are disposed in such a manner that the images read by them are slightly overlapping. Furthermore, although not illustrated in FIG. 20, as an illumination device for determination, a xenon fluorescent lamp is disposed on the rear surface of a bracket 375, on the side of the recording medium, and a white reference plate is inserted periodically between the image and the illumination source so as to measure a white reference. In this state, the lamp is extinguished and a black reference level is measured.

The reading width of the line CCD 370 (the extent to which the determination can be performed in one action) can be designed variously in accordance with the width of the image recording range on the recording medium. From the viewpoint of lens performance and resolution, for example, the reading width of the line CCD 370 is approximately ½ of the width of the image recording range (the maximum width which can be scanned).

The image data obtained by the line CCD 370 is converted into digital data by an A/D converter, or the like, and then stored in a temporary memory, whereupon the data is processed through the system controller 272 (see FIG. 19) and stored in the memory 274.

### <Recording Medium>

In implementing the present invention, there are no particular restrictions on the material or shape, or other features, of the recording medium, and it is possible to employ various different media, irrespective of their material or shape, such as continuous paper, cut paper, seal paper, OHP sheets or other resin sheets, film, cloth, a printed substrate on which a wiring pattern, or the like, is formed, or a rubber sheet.

### <Device for Causing Relative Movement of Head and Paper>

In the embodiment described above, an example is given in which a recording medium is conveyed with respect to a stationary head, but in implementing the present invention, it is also possible to move a head with respect to a stationary recording medium (image formation receiving medium).

### <Application of the Present Invention>

In the embodiments described above, application to the inkjet recording apparatus for graphic printing has been described, but the scope of application of the present invention is not limited to this. For example, the present invention can be applied widely to inkjet systems which forms various shapes or patterns using liquid function material, such as a wire printing apparatus, which forms an image of a wire pattern for an electronic circuit, manufacturing apparatuses for various devices, a resist printing apparatus, which uses resin liquid as a functional liquid for ejection, a color filter manufacturing apparatus, a fine structure forming apparatus for forming a fine structure using a material for material deposition, or the like.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of printing a test pattern for ascertaining ejection characteristics of a plurality of nozzles arranged in a recording head in an inkjet recording apparatus which forms and records a desired image on a recording medium by performing ejection of droplets of liquid from the recording head through the nozzles and deposition of the droplets onto the recording medium while causing relative movement of the recording head and the recording medium, the method comprising the steps of:
performing ejection of droplets of the liquid from the recording head by applying, to the recording head, a drive signal having a test waveform in which at least one of a voltage, a frequency and a waveform shape is altered with respect to a drive signal having a recording waveform which is applied to the recording head when the desired image is formed and recorded on the recording medium, to thereby perform the ejection with an increased ejection force compared with a case where the drive signal having the recording waveform is applied to the recording head; and
forming the test pattern by depositing the droplets ejected in the ejection step onto the recording medium.

2. The method as defined in claim 1, wherein the voltage of the test waveform is not higher than 1.3 times the voltage of the recording waveform.

3. The method as defined in claim 1, wherein an ejection frequency produced by the drive signal having the test waveform is not higher than 5 kHz.

4. The method as defined in claim 1, wherein an ejection frequency produced by the drive signal having the test waveform is not lower than 20 kHz.

5. The method as defined in claim 1, further comprising the steps of:
identifying a defective ejection nozzle among the nozzles from a result of printing the test pattern;
performing second ejection of droplets of the liquid from the recording head by further increasing an ejection force only for the defective ejection nozzle compared with a case where the drive signal having the test waveform is applied, by applying, to the recording head, a drive signal having a re-test waveform in which at least one of the voltage and the waveform shape is altered with respect to the drive signal having the test waveform; and
depositing the droplets ejected in the second ejection step onto the recording medium.

6. The method as defined in claim 5, further comprising the steps of:
reprinting a test pattern after the second ejection step and before starting to form and record the desired image; and
identifying a defective ejection nozzle among the nozzles from a result of reprinting the test pattern.

7. The method as defined in claim 1, further comprising the steps of:
identifying a defective ejection nozzle among the nozzles from a result of printing the test pattern;
driving only the defective ejection nozzle to eject a droplet of the liquid; and
depositing the droplet ejected in the driving step onto the recording medium.

8. The method as defined in claim 1, wherein the test pattern includes line patterns respectively for the nozzles whereby a result of ejection of each of the nozzles is identified distinguishably from results of ejection of others of the nozzles on the recording medium.

9. The method as defined in claim 8, wherein the test pattern includes the line patterns formed by performing ejection simultaneously from the nozzles in positions separated from each other by an interval of larger than one nozzle pitch in an effective sequence of the nozzles aligned in a widthwise direction of the recording medium which is perpendicular to the direction of the relative movement, in such a manner that no ejection is performed simultaneously from the nozzles which are mutually adjacent in the effective sequence of the nozzles.

10. The method as defined in claim 1, wherein the test pattern is formed by performing the ejection while raising the voltage of the drive signal stepwise.

11. The method as defined in claim 1, wherein the test pattern is formed by performing the ejection while changing an ejection frequency stepwise.

12. The method as defined in claim 11, wherein modulation of the ejection frequency is performed using test pattern image data.

13. The method as defined in claim 1, wherein the test pattern has a portion in which ejection is performed by applying a drive signal having the recording waveform and a recording frequency after the ejection is performed by applying the drive signal having the test waveform.

14. The method as defined in claim 1, wherein the test waveform contains a section in which rectangular waves are arranged at an interval substantially equal to a resonance period of the recording head.

15. The method as defined in claim 1, wherein the printing of the test pattern is performed before starting to faun and record the desired image.

16. The method as defined in claim 1, wherein the printing of the test pattern is performed after performing at least a specified number of droplet ejections to form and record the desired image.

17. The method as defined in claim 1, wherein the printing of the test pattern is performed after forming and recording at least a specified number of the desired image.

18. An inkjet recording apparatus, comprising:
a recording head which includes a plurality of nozzles through which droplets of liquid are ejected and a plurality of pressure generating elements corresponding to the nozzles;
a conveyance device which causes relative movement of the recording head and a recording medium by conveying at least one of the recording head and the recording medium;
a recording ejection control device which forms and records a desired image on the recording medium by controlling ejection of droplets from the recording head while controlling the relative movement, and by depositing the droplets onto the recording medium; and
a test pattern formation control device which controls ejection of droplets from the recording head in such a manner that, when a test pattern for ascertaining ejection characteristics of the nozzles is printed on the recording medium, the recording head is applied with a drive signal having a test waveform in which at least one of a voltage, a frequency and a waveform shape is altered with respect to a drive signal having a recording waveform which is applied to the recording head when the desired image is formed and recorded on the recording medium, to thereby perform the ejection with an increased ejection force compared with a case where the drive signal having the recording waveform is applied to the recording head, and in such a manner that the test pattern is formed by depositing the ejected droplets onto the recording medium.

19. The inkjet recording apparatus as defined in claim 18, further comprising:
an image reading device which reads in a result of printing the test pattern; and
a signal processing device which performs calculation for identifying a defective ejection nozzle among the nozzles from information acquired by the image reading device.

20. The inkjet recording apparatus as defined in claim 18, further comprising an image correction device which compensates for an output of a defective ejection nozzle among the nozzles identified from a result of printing the test pattern, using the nozzles other than the defective ejection nozzle.
